(19) United States
(12) Patent Application Publication
(10) Pub. No.: US 2026/0170457 A1
(43) Pub. Date: Jun. 18, 2026

(54) SYSTEMS AND METHODS OF FACILITATING PLANNING OF MEALS FOR USERS

(71) Applicant: Jennifer Ellen Gardner, Leander, TX (US)

(72) Inventor: Jennifer Ellen Gardner, Leander, TX (US)

(21) Appl. No.: 19/410,965

(22) Filed: Dec. 5, 2025

Related U.S. Application Data
(60) Provisional application No. 63/734,659, filed on Dec. 16, 2024.

(51) Int. Cl. G06Q 10/087; G09B 19/00

(52) U.S. Cl. CPC G06Q 10/08774; G09B 19/0092

(57) ABSTRACT

A method of facilitating planning of meals for users. Further, the method includes retrieving a meal plan information of a meal plan for one or more users. Further, the method includes accessing one or more databases. Further, the method includes executing one or more Artificial Intelligence (AI) models. The one or more AI models are configured for processing two or more food item information of two or more food items and selecting one or more food items from the two or more food items for a meal using one or more variables associated with the one or more users. Further, the method includes generating one or more instructions for creating the meal. Further, the method includes transmitting the one or more instructions to one or more devices associated with the one or more users. Further, the method includes storing the one or more variables.

### FIELD OF THE INVENTION

The present disclosure generally relates to the field of data processing. More specifically, the present disclosure relates to systems and methods of facilitating planning of meals for users.

### BACKGROUND OF THE INVENTION

The present disclosure generally relates to the field of intelligent household meal management and preparation systems that utilize computational intelligence for optimizing food preparation, storage, and consumption. The field is of significant importance as modern households increasingly rely on digital and automated technologies to manage daily activities efficiently while maintaining nutritional balance, reducing waste, and adapting to dynamic lifestyle schedules. Effective management of household cooking processes and ingredient inventories directly contributes to sustainability, time optimization, and health outcomes, making household cooking processes a critical area of ongoing technological advancement.

An important objective in the field is to enable households to plan, prepare, and consume meals in a way that maximizes efficiency, freshness, and variety while minimizing food waste and effort. Achieving the objective requires systems that can adapt to the constantly changing availability of ingredients, user preferences, dietary constraints, and time limitations, while also integrating sustainability principles and data-driven personalization.

However, existing meal planning and cooking management systems face several challenges in achieving the objective. Many known systems rely on static databases or manually entered meal plans, which do not dynamically adjust to real-world conditions such as ingredient spoilage, changes in user schedules, or fluctuating household needs. As a result, users frequently encounter inefficiencies in food utilization, including over-purchasing, premature spoilage, and repetitive meal patterns.

Additionally, current inventory management platforms often lack integration between inventory tracking, preparation sequencing, and leftover repurposing, resulting in fragmented workflows and missed opportunities for resource optimization. The systems typically treat meal planning, ingredient storage, and cooking processes as isolated functions, preventing continuous coordination between the meal planning, the ingredient storage, and the cooking processes. Consequently, users are unable to benefit from adaptive planning that reflects the real-time household circumstances.

Further, traditional digital cooking assistants have limited ability to account for contextual variables such as perishability, preparation workload, energy usage, and equipment availability. The traditional digital cooking assistants do not dynamically balance tasks across multiple appliances or intelligently segment cooking processes to improve time and energy efficiency. Leading to suboptimal meal quality, unnecessary labor intensity, and inconsistent cooking outcomes. Moreover, most systems fail to provide meaningful insight into nutritional trends or sustainability impacts associated with daily cooking routines. Users seeking long-term dietary improvement or eco-conscious consumption lack predictive or analytical tools that guide ingredient selection and cooking strategies. Additionally, household data privacy and scalability are often compromised in centralized systems, preventing the safe exchange of aggregated insights or community-driven optimization.

Therefore, there is a need for improved systems and methods of facilitating planning of meals for users that can overcome one or more of the preceding problems.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating planning of meals for users. Further, the method may include retrieving, using a storage device, a meal plan information of a meal plan for one or more users. Further, the meal plan includes two or more meals at two or more mealtimes. Further, the method may include accessing, using a processing device, one or more databases. Further, the one or more databases include two or more food item information of two or more food items. Further, each of the food item information corresponds to a respective one of the two or more food items. Further, the method may include executing, using the processing device, one or more Artificial Intelligence (AI) models based on the accessing and the retrieving. Further, the one or more AI models may be configured for processing the two or more food item information of the two or more food items based on the meal plan information. Further, the one or more AI models may be configured for selecting one or more food items from the two or more food items for a meal using one or more variables associated with the one or more users based on the processing of the two or more food item information. Further, the method may include generating, using the processing device, one or more instructions for creating the meal based on the selecting. Further, the method may include transmitting, using a communication device, the one or more instructions to one or more devices associated with the one or more users. Further, the method may include storing, using the storage device, the one or more variables.

The present disclosure provides a system for facilitating planning of meals for users. Further, the system may include a storage device. Further, the storage device may be configured for retrieving a meal plan information of a meal plan for one or more users. Further, the meal plan includes two or more meals at two or more mealtimes. Further, the system may include a processing device communicatively coupled with the storage device. Further, the processing device may be configured for accessing one or more databases. Further, the one or more databases include two or more food item information of two or more food items. Further, each of the food item information corresponds to a respective one of the two or more food items. Further, the processing device may be configured for executing one or more Artificial Intelligence (AI) models based on the accessing and the retrieving. Further, the one or more AI models may be configured for processing the two or more food item information of the two or more food items based on the meal plan information. Further, the one or more AI models may be configured for selecting one or more food items from the two or more food items for a meal using one or more variables associated with the one or more users based on the processing of the two or more food item information. Further, the system may include a communication device communicatively coupled with the processing device. Further, the communication device may be configured for transmitting the one or more instructions to one or more devices associated with one or more users.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of facilitating planning of meals for users, in accordance with some embodiments.

FIG. 4A illustrates a flowchart of a method 400 of facilitating planning of meals for users including generating, using the processing device 804, at least one processed food item information for the at least one processed food item, in accordance with some embodiments.

FIG. 4B illustrates a continuation flowchart of the method 400 of facilitating planning of meals for users including generating, using the processing device 804, at least one processed food item information for the at least one processed food item, in accordance with some embodiments.

FIG. 5 illustrates a flowchart of a method 500 of facilitating planning of meals for users including updating, using the processing device 804, the at least one database after the consumption of the meal, in accordance with some embodiments.

FIG. 6 illustrates a flowchart of a method 600 of facilitating planning of meals for users including determining, using the processing device 804, a meal consumption pattern for the at least one user, in accordance with some embodiments.

FIG. 7 illustrates a flowchart of a method 700 of facilitating planning of meals for users including analyzing, using the processing device 804, the at least one feedback, in accordance with some embodiments.

FIG. 8 illustrates a block diagram of a system 800 of facilitating planning of meals for users, in accordance with some embodiments.

FIG. 9 illustrates a flowchart of a method 900 of facilitating planning of meals for users including classifying, using the processing device 804, the plurality of food items into a plurality of categories, in accordance with some embodiments.

FIG. 10A illustrates a flowchart of a method 1000 of collecting a plurality of user inputs, in accordance with some embodiments.

FIG. 10B illustrates a continuation flowchart of the method 1000 of collecting the plurality of user inputs, in accordance with some embodiments.

FIG. 11 illustrates a flowchart of a method 1100 of generating a guidance information, in accordance with some embodiments.

FIG. 12 illustrates a flowchart of a method 1200 of collecting at least one weekly user input, in accordance with some embodiments.

FIG. 13A illustrates a flowchart of a method 1300 of generating an AI output, in accordance with some embodiments.

FIG. 13B illustrates a continuation flowchart of the method 1300 of generating the AI output, in accordance with some embodiments.

FIG. 14A illustrates a system architecture 1400 of facilitating planning of meals for users, in accordance with some embodiments.

FIG. 14B illustrates the system architecture 1400 of facilitating planning of meals for users, in accordance with some embodiments.

FIG. 15 illustrates a flowchart of a method 1500 of facilitating planning of meals for users, in accordance with some embodiments.

FIG. 16 illustrates a flowchart of a method 1600 of facilitating planning of meals for users, in accordance with some embodiments.

FIG. 17 illustrates a flowchart of a method 1700 of facilitating a meal preparation, in accordance with some embodiments.

FIG. 18 illustrates a flowchart of a method 1800 of facilitating a meal preparation, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes a Progression Cooking. Core process outline of Progression Cooking:
1. Inventory Tracking
   Input Methods: User enters food items manually (via text entry or selection menus) or by confirming AI-suggested matches from a predefined database of common foods.
   Categorization: System automatically classifies items into categories (proteins, produce, pantry staples, frozen, garden-sourced).
   Tracking & Monitoring:
   AI assigns metadata (quantity, storage location, expiration date).
   System flags items nearing expiration for priority use.
   Data Storage: Inventory data is stored in a dynamic database linked to the household profile, allowing updates and retrieval at any time.
2. Protein Preparation (batch Step)
   Selection: User designates proteins from the inventory for bulk preparation.
   AI Processing:
   AI generates preparation instructions tailored to the chosen protein (e.g., marinating, par-baking, portioning, freezing).
   AI calculates optimal portion sizes based on household size, dietary preferences, and upcoming meals.
   Output: Proteins are prepped in a structured, multi-day sequence so the proteins can be quickly finished and served fresh later.
3. AI Meal Planning
   Input Variables: AI considers available proteins, full inventory, dietary restrictions, kitchen equipment, and family preferences.
   Algorithm:
   AI generates a schedule of meals optimized for freshness, nutrition, and minimal waste.
   AI uses a progressive sequencing approach (Day 1—Day 2—Day 3) where each day's meal builds on prior preparation.
   Output:
   Users receive meal plans with step-by-step instructions.
   Plans specify “prep-day tasks” vs. “cook-day finishing tasks.”
   Adaptability: If a user updates the inventory, skips a meal, or changes preferences, AI recalculates future plans dynamically.
4. Leftover Utilization
   Input Recognition: The System identifies leftovers entered by the user or inferred from planned vs. consumed portions.
   AI Repurposing: AI matches leftovers with compatible recipes (e.g., roasted chicken—chicken salad wraps, soups, or casseroles).
   Output: Suggestions are integrated into the upcoming meal plan, replacing or modifying future meals automatically.
5. User Interaction
   Interface: Users interact via mobile app screens that provide daily instructions.
   Task Differentiation:
   Prep instructions are grouped into a single, front-loaded “batch prep day.”
   Cooking instructions are simplified to short, fresh-day steps.
   Feedback Loop:
   Users rate meals and confirm which tasks were completed.
   AI refines future plans based on the feedback (e.g., portion adjustments, recipe substitutions, cooking style preferences).

The present disclosure relates generally to a comprehensive household management system designed to simplify and optimize daily life through advanced AI-driven processes, proprietary algorithms, and user-friendly interfaces. A number of applications for organizing data and schedules are known in the art. The applications can be either standalone or can operate among groups of users that may be linked, for example, via an Intranet. In daily family life, however, various tasks that may be interrelated have to be performed repeatedly and at regular time intervals. Family events, such as birthdays and anniversaries, have to be monitored; there may be an interest in consolidating financial statements and shopping for the best available offers based on the family's resources.

The present disclosure intends to accomplish the comprehensive optimization of household management by integrating meal planning, lifestyle routines, and sustainability principles into a unified, AI-driven system. The primary goal is to simplify and streamline household management, wherein routine tasks such as meal planning, grocery shopping, home maintenance, and personal care scheduling are automated and simplified; minimize resource waste, wherein food and material waste are reduced by optimizing inventory management, repurposing leftovers, and encouraging eco-friendly practices; and empower users to maintain a balanced, efficient, and eco-friendly household, wherein educational resources on advanced cooking techniques, household safety, and sustainability are provided. The present disclosure addresses the challenges of modern households by providing dynamic, personalized solutions that save time, reduce stress, and support sustainable living practices. The present disclosure helps households maintain a healthy, balanced lifestyle by addressing dietary needs, financial goals, personal wellness, and home care in an interconnected way.

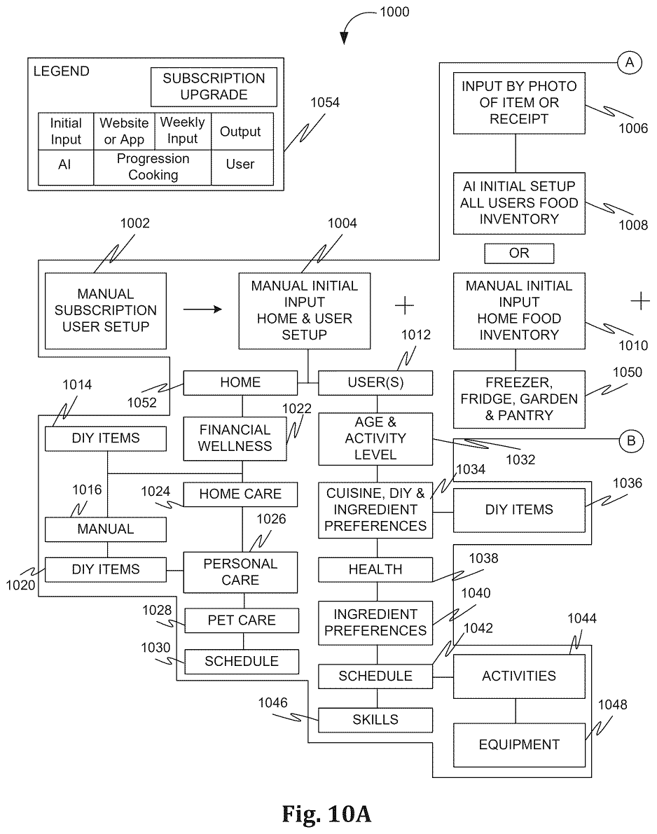

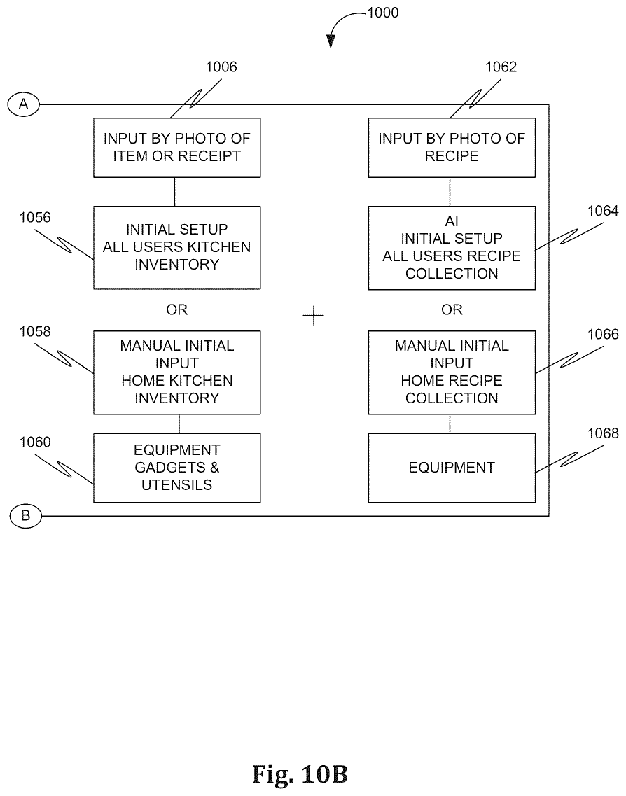

Referring to FIG. 10A and FIG. 10B, a user initially sets up a subscription 1002 (FIG. 10A) to use the household management system. The user then manually inputs information representing personal aspects of the individual user and the user's home life 1004 (FIG. 10A), as well as aspects of home with regards to food inventory 1008 (FIG. 10A), kitchen inventory 1056 (FIG. 10B), and recipe collection 1064 (FIG. 10B). Additionally, the user has the option to upload photos representing an inventory of food at the home 1008 (FIG. 10A), an inventory of kitchen items at the home 1056 (FIG. 10B), and a collection of recipes at the home 1064 (FIG. 10B). Upon uploading of the photos, an Artificial Intelligence engine (AI) will catalog the food inventory 1008 (FIG. 10A), the kitchen inventory 1056 (FIG. 10B), and the collection of recipes 1064 (FIG. 10B).

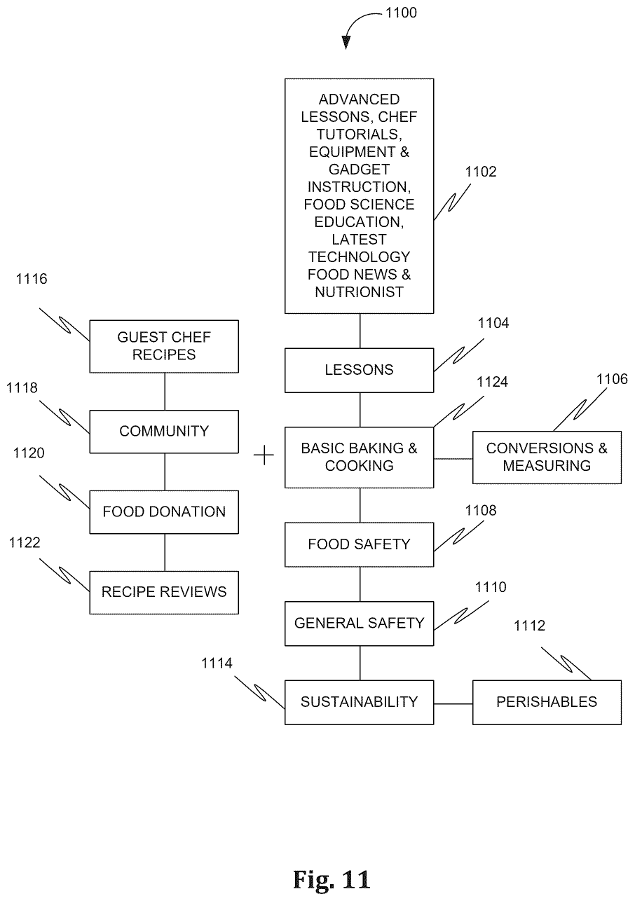

Referring to FIG. 11, guidance information is provided by the home management system to the user in the form of cooking lessons, equipment instructions, and/or food education 1102, and guest recipes 1116.

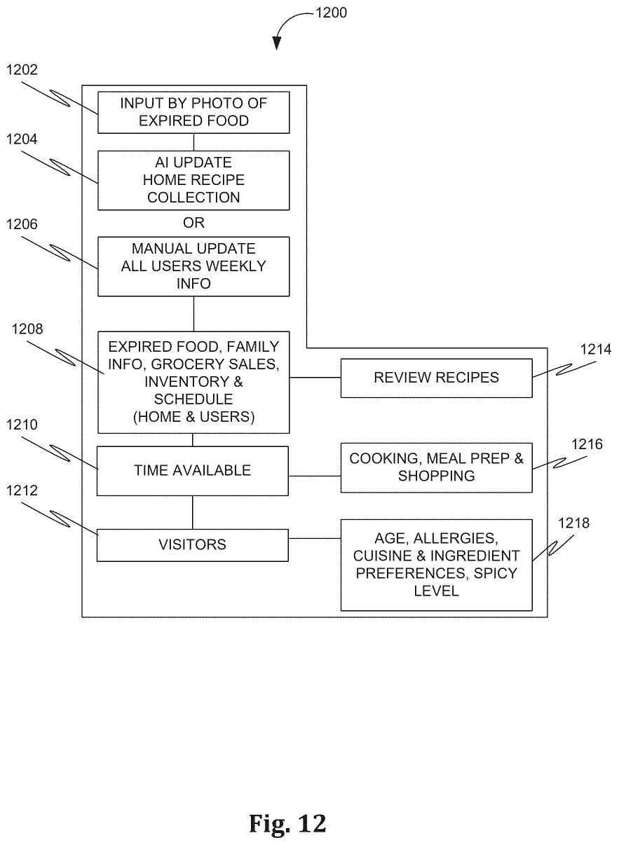

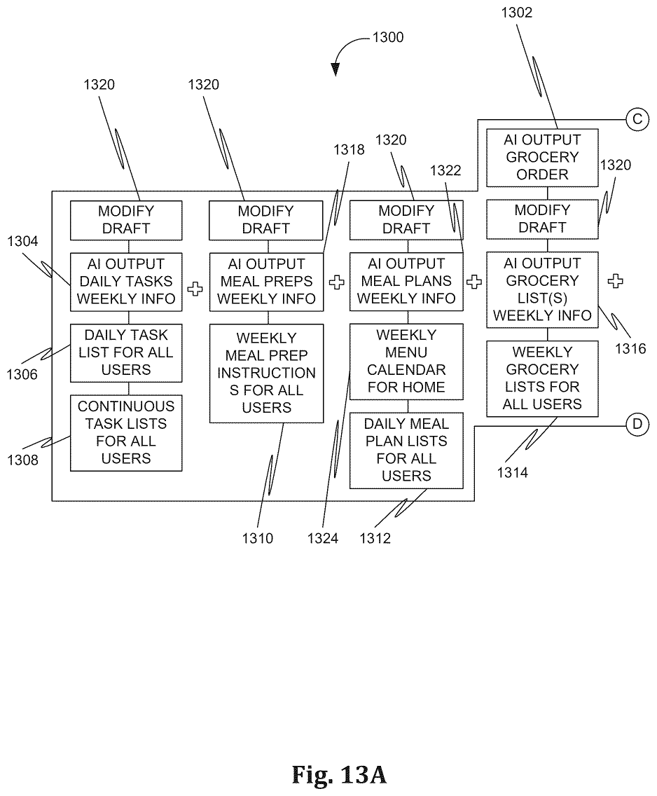

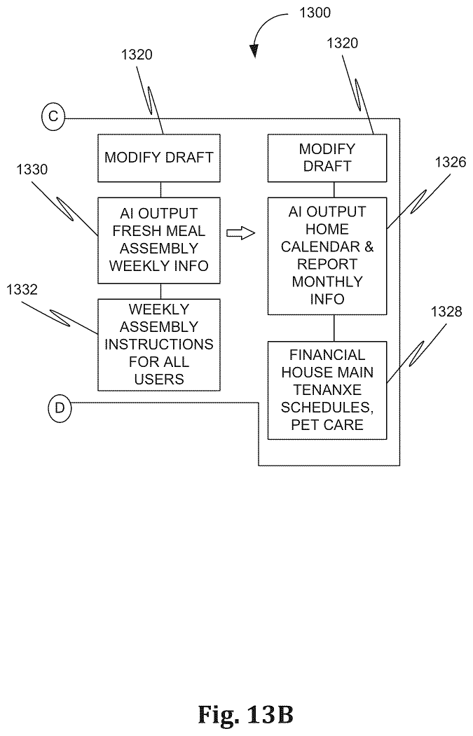

Referring to FIG. 12, the user has the option to manual input information regarding aspects of week 1206 to the home management system which impacts the AI engine generated outputs displayed in FIG. 13A and FIG. 13B. Additionally, the user can upload photos with regards to expired food 1202 and thus update the existing home recipe collection 1204 the AI engine will reference in creating meals for the day and/or week.

Referring to FIG. 13A and FIG. 13B, the AI engine generated outputs of the household management system regarding daily tasks 1304, meal preparation 1318, meal plans 1322, grocery list 1316, a fresh meal 1330, and a home report 1325 are displayed.

The core function of the present disclosure is to streamline and optimize household meal planning, preparation, and related activities using a proprietary system. The household management system integrates user input, AI-driven algorithms, and rule-based logic to create a seamless process for managing home food inventory, recipe collections, and meal planning. The household management system dynamically adapts to user preferences, available resources, and dietary restrictions to provide personalized meal solutions with minimal food waste and time investment. Key components of the household management system include: comprehensive data integration, AI-driven optimization, and dynamic adaptation.

The household management system collects household data such as food inventory, kitchen equipment, recipes, family preferences, health considerations, and schedules the user inputs manually or via photo scanning, wherein the household management system organizes the household data. The household management system utilizes an AI engine to interpret user inputs, wherein the AI engine analyzes the input data, identifies patterns, and updates inventories, schedules, and plans in real-time. The AI engine also analyzes photos of receipts, food items, or recipes to update inventories, identify ingredients, and categorize items automatically. The AI engine uses proprietary algorithms to generate custom outputs like meal plans matching with user preferences, based on available ingredients and dietary needs, all the while minimizing food waste and creating efficient schedules for daily tasks, home maintenance, personal care routines, and family events.

The household management system learns from user interactions and feedback, wherein the AI engine will learn household preferences, dietary restrictions, and usage patterns over time, enabling better personalization of outputs. The household management system evolves, continuously improving and adapting to household needs, incorporating leftover reuse, time-sensitive scheduling, and sustainability principles to reduce waste and adapt to unexpected changes. The household management system adjusts outputs to accommodate unexpected changes like schedule disruptions, ingredient shortages, or dietary updates.

In a preferred embodiment, a user utilizes the household management system to plan out the schedule for the given week. The user subscribes to the household management system, wherein the user inputs initial data such as age, activity level, health, and food preferences, as well initial data about the home regarding the kitchen, such as food inventory, kitchen inventory i.e. cooking equipment, and recipe collections, as well as the home in general such as whether there is a pet in the home, household chores and responsibilities. Once the initial data has been inputted, the user will set the preferences for the week with respect to the dietary wants, how often the user will cook, and how best to utilize both used and unused food items.

One function of the household management system is to generate a grocery list. The user will upload photos of a Sunday flyer for the local grocery store. The household management system utilizes an Artificial Intelligence (AI) engine to identify the food items for the user to purchase, aligning with the user's meal preferences for the week, as well as any other additional items aligning with the user's home requirements.

Another function of the household management system is to provide the user with a step-by-step instruction for preparing the ingredients for the meals to be cooked in the given week. The AI engine will divide out the ingredients amongst the meals to be prepared, indicating what meal items can be cooked in entirety and the means to do so, as well as how best to store the prepared items for future use. Additionally, the household management system will provide the user with a daily task regarding the steps to be taken to cook the meal for the given day. Then, at the end of the week, the household management system will summarize the actions taken and benefits for the week, such as the number of meals prepared, how food waste was reduced, and what food items have been stored for future use.

The household management system also provides the user with guidance on sustainability, such as how to repurpose food scraps or create homemade products using household items.

### Working of the Household Management System

Step 1—Household Inventory Capture
   The system receives inventory information from the household.
   Users may enter items manually (e.g., “5 lbs. chicken breast, fridge”), scan barcodes, or confirm AI-generated suggestions.
   Each item is stored with attributes such as type (protein, produce, pantry), quantity, storage location (fridge, freezer, pantry), and expiration window.
   The AI assigns a perishability score to each item based on the category, storage, and shelf life.
Step 2—Protein Identification and Prioritization
   The AI scans the inventory to prioritize proteins as the anchor of meal planning.
   Factors considered:
   Perishability (time until expiration), Quantity available, Household preferences and dietary restrictions, Prior waste patterns
   High-priority proteins are flagged for inclusion in the Prep Day batch plan.
Step 3—Batch Preparation (“Prep Day”)
   On a designated day, the system generates a batch-prep plan.
   Proteins are divided into flavor/method groups (e.g., part grilled, part marinated, part pre-cooked).
   The system calculates portion sizes and yields (raw—trimmed—cooked) and assigns storage states (e.g., cooked portions in fridge, marinated raw portions frozen).
   A step-by-step checklist is produced, including cooking times, temperatures, and storage instructions.
   The AI balances workload across available kitchen tools (e.g., oven, slow cooker, grill) for efficiency.
Step 4—Daily Meal Assembly (Fresh Cooking)
   The system retrieves available protein modules from inventory.
   The AI pairs the protein modules with side items already in inventory or substitutes with alternatives if something is missing.
   The user receives simple cook-fresh instructions (e.g., “Reheat marinated chicken, add steamed broccoli, serve with rice”).
   AI adjusts cook times dynamically based on portion sizes and the cooking method chosen.
Step 5—Leftover Tracking and Repurposing
   After meals, any unused portions are logged back into inventory as leftovers (e.g., “shredded chicken, 300 g, fridge, 2 days to expire”).
   The AI automatically suggests next-day repurposing (e.g., chicken tacos, chicken salad, stir-fry) to reduce waste.
   The process extends the usefulness of each protein batch and keeps meals varied across the week.
Step 6—Continuous Learning and Optimization
   The AI collects user ratings (taste, prep effort, family approval).
   The inputs adjust future plans by:
   Increasing or decreasing certain flavor profiles, Right-sizing portion sizes, adjusting prep vs. fresh balance, and highlighting substitutions that worked well.
Novelty of the System
   Uses AI to transform household inventory into a phased cooking process (batch prep—daily fresh assembly).
   Proteins are centrally prioritized to drive the plan, maximizing efficiency and variety.
   Tracks state changes of food (raw—prepped—cooked—leftover) to minimize waste.
   Automates repurposing of leftovers into new meals rather than simply reheating.
   Provides a dynamic, adaptive loop: inventory in—batch prep—daily meals—leftovers repurposed—updated inventory.

### Independent Aspect

1. A computer-implemented method for household meal preparation, comprising:
   receiving inventory data for a plurality of food items, wherein the inventory data includes at least a food type, quantity, storage location, and expiration information;
   identifying one or more protein items within the inventory;
   assigning a priority score to each protein item based on perishability, available quantity, and household preferences;
   generating a batch-preparation plan, where the batch-preparation plan allocates portions of the protein items into multiple preparation methods, wherein the preparation methods include at least one of: marination, partial cooking, full cooking, seasoning, or freezing;
   storing the prepared portions as inventory items with updated states and expiration information;
   generating daily meal assembly instructions, where the daily meal assembly instructions combine the prepared protein portions with additional inventory items to produce meals;
   updating the inventory after each meal to record consumed portions and leftover portions; and
   repurposing leftover portions into subsequent meals by generating meal instructions, where the meal instructions incorporate the leftovers.

### Dependent Aspects

The method of aspect 1, wherein the inventory data is received via user input into a mobile application.
The method of aspect 1, wherein the priority score further comprises a waste-risk factor based on historical patterns of unused food.
The method of aspect 1, wherein the batch-preparation plan includes assigning flavor profiles to protein portions to diversify meals.
The method of aspect 1, wherein storing prepared portions comprises recording a transformation state from raw to prepped to cooked to leftover.
The method of aspect 1 further comprises dynamically adjusting the daily meal assembly instructions based on calendar events, available cooking time, or household schedule changes.
The method of aspect 1, wherein repurposing leftovers comprises assigning new recipes, where the new recipes differ from the original meal in preparation method or flavor profile.
The method of aspect 1 further comprises receiving user ratings of meals and updating future preparation plans based on the ratings.

### Independent Aspect 2—System Aspect

A system for household meal preparation, comprising:
a mobile device configured to receive inventory input from a user;
a database storing inventory records including food type, storage location, quantity, and expiration information;
A planning engine configured to:
identify proteins within the inventory,
generate a batch-preparation plan for the proteins using multiple preparation methods, and
generate daily meal assembly instructions using the prepared proteins and additional items; and
A machine learning engine configured to:
score and prioritize proteins based on perishability, household preferences, and waste patterns,
record state changes of food items, including raw, prepped, cooked, and leftover, and
adapt future batch-preparation plans based on consumption history and user feedback.

A non-transitory computer-readable medium storing instructions, when the instructions are executed by a processor, causes the processor to perform the steps of the method of aspect 1.

In some embodiments, the system may include an AI engine configured to dynamically structure inventory data using multi-parameter perishability modeling. The technical problem addressed by the feature is the inaccuracy and inefficiency of traditional inventory tracking systems that rely on static date-based expiration or user-entered data, which often leads to mismanagement and food waste. The improvement lies in generating a real-time perishability score derived from cross-linked metadata such as food type, category, temperature profile, storage medium, and usage frequency. The technology being improved is digital inventory management systems for perishable goods.

In some embodiments, the AI engine may employ machine learning algorithms such as time-series decay modeling or Bayesian degradation prediction, which continuously refine perishability estimates using historical consumption data. For example, a protein item stored in a freezer may receive an extended perishability score based on actual temperature logs, whereas leafy greens may decay faster depending on humidity levels inferred from sensor data.

In some embodiments, implementation may include IoT-enabled sensors or image-recognition systems to automatically capture item condition and update the decay model. For instance, a refrigerator camera may detect visual discoloration and trigger a recalculation of the perishability score.

In some embodiments, the system may employ a progressive sequencing model that structures meal preparation into interlinked phases (e.g., batch prep—cook day—leftover repurposing). The technical problem addressed is inefficiency in sequential meal planning, where traditional systems fail to adapt across multiple days or reuse intermediate states of food preparation. The improvement enhances AI-driven meal planning technology by integrating reinforcement learning algorithms that reward the system for achieving freshness, variety, and waste minimization. The model may iteratively learn optimal sequences, such as when to marinate proteins, when to freeze partial portions, or when to repurpose leftovers into new recipes.

In some embodiments, the sequencing engine may evaluate multi-objective functions such as “flavor continuity,” “time utilization,” and “waste avoidance.” For example, the system may determine that marinating chicken on Day 1 and grilling half while freezing half yields superior efficiency compared to ad hoc preparation. The sequencing logic may be generalized into an adaptive scheduling matrix, where user behavior feedback dynamically reshapes subsequent weeks' cooking routines.

In some embodiments, the system may employ a protein-prioritization algorithm that identifies and ranks protein items as the central anchors of meal plans. The technical problem addressed is the lack of context-awareness in existing meal planning systems, which typically treat ingredients independently rather than hierarchically. The system may use a multi-factor scoring mechanism that weighs perishability, availability, dietary preferences, and previous consumption frequency. The technology being improved is automated food recommendation engines.

In some embodiments, the system may employ a weighted decision tree or gradient boosting model to compute a “protein priority index,” which then guides all downstream preparation logic. For instance, proteins nearing expiration may automatically be allocated to upcoming batch-prep sessions, while frozen items with long shelf lives are deferred.

In some embodiments, the system may incorporate a machine-learning module trained to identify, classify, and repurpose leftover items into new recipes. The technical problem addressed is that traditional recipe systems lack intelligent handling of food already cooked or partially used. The improvement advances culinary recommendations and sustainability technology by creating an AI engine capable of understanding ingredient transformations. For instance, the system may map “roasted chicken breast” to compatible future dishes such as “chicken fried rice” or “pasta carbonara.”

In some embodiments, the system may employ natural language processing (NLP) models trained on recipe databases to match ingredient contexts semantically, and may also integrate computer vision to identify leftover types from user-uploaded images. Over time, may refine the recommendations based on household-specific taste ratings.

In some embodiments, the system may include an intelligent task scheduler that optimizes cooking workloads across available household devices (e.g., oven, grill, air fryer, sous vide). The technical problem addressed is the inefficient or conflicting use of appliances during batch-prep sessions. The improvement enhances kitchen automation and resource scheduling technology by introducing an AI-based load-balancing system. The scheduler may distribute cooking tasks temporally and thermally to avoid overload and energy waste. For instance, the system may suggest pre-baking proteins while slow-cooking legumes, ensuring both finish concurrently.

In some embodiments, the scheduler may dynamically reassign tasks based on real-time device status or sensor feedback (e.g., temperature deviation or occupancy) and may further use predictive modeling to anticipate energy peaks and optimize for cost efficiency.

In some embodiments, the system may include a self-improving learning loop that refines predictions and recommendations based on user ratings, completion logs, and historical trends. The technical problem addressed is the static, one-size-fits-all nature of conventional recommendation systems that fail to evolve with household habits. The improvement benefits personalized AI systems by integrating continuous contextual learning. For example, if a household consistently skips complex recipes, the system may autonomously favor simpler meal structures. In another embodiment, seasonal availability patterns may adjust recipe databases dynamically. The mechanism may be implemented through online learning architectures, where model parameters are updated incrementally after every interaction, rather than requiring retraining from scratch.

In some embodiments, a generative model (e.g., transformer-based or diffusion-based AI) may create novel flavor combinations based on household ingredient data. The technical problem addressed is the limited recipe diversity within fixed databases. The improvement enhances AI-based culinary creativity engines by enabling real-time synthesis of new recipe formulations based on user taste profiles, available inventory, and nutritional goals.

In some embodiments, the system may employ a vision model trained to detect spoilage cues (e.g., colour change, texture irregularities) through refrigerator cameras or smartphone uploads. Thus, improving computer vision applications in food freshness detection by moving beyond barcode or date reliance. Implementation may include a convolutional neural network fine-tuned on perishable food datasets.

In some embodiments, a nutritional forecasting engine may predict long-term dietary balance by analyzing historical ingredient usage and planned meals. The technical problem addressed is that existing systems optimize for meal scheduling rather than nutritional trajectory. Thus, improving digital health monitoring technology by incorporating predictive analytics using reinforcement signals from user satisfaction and biometric feedback.

In some embodiments, the system may integrate blockchain ledgers to log every food transformation (raw—repped—cooked—leftover—repurposed). The improvement enhances food traceability technology by ensuring immutable records of food lifecycle events. The feature may be used for sustainability tracking, compliance with zero-waste certifications, or smart-contract-based grocery incentives.

In some embodiments, the system may connect multiple household instances into a federated learning network, allowing collaborative optimization of recipes and sustainability outcomes without sharing raw personal data. The improvement benefits distributed AI systems by enhancing model generalization through privacy-preserving learning. For example, regional consumption trends may help improve local ingredient prioritization models.

In certain embodiments, the system comprises: (i) a processing device including one or more processors configured to execute program instructions; (ii) a non-transitory storage device configured to store data records; and (iii) a communication device configured to exchange data with user devices and, in some implementations, kitchen appliances. The processing device executes software components, including, without limitation, a user profile and inventory module, a planning and optimization engine, an instruction generator, and a feedback and learning module. Interconnections among these components are implemented via one or more system buses and/or network interfaces.

As used herein, the terms “module,” “engine,” “component,” “processor,” and “device” refer to structures comprising hardware, firmware, and/or software executing on hardware. For software-implemented functions, the corresponding structure comprises at least the processor(s) programmed to execute the disclosed algorithms, associated memory storing the disclosed data structures, and the described interconnections and I/O interfaces.

In exemplary implementations, “meal plan information” may include fields identifying a meal identifier, a mealtime, a recipe reference, a serving count, an assigned user, device constraints, a preparation window, and a thaw window. “Food item information” may include fields identifying an item identifier, category, quantity, storage location, expiration timestamp, state (for example, raw, prepped, cooked, or leftover), a nutrition vector, allergens, and cost per unit. A “variable associated with the user” may include a dietary profile, taste preferences, a calorie target, macronutrient targets, a budget, schedule availability, an equipment list, household size, and historical waste rate. “Processed food item information” may include a reference to a source raw item, process type, yield mass, doneness target, storage state, and an updated expiration timestamp. “Meal consumption information” may include a meal identifier, planned servings, consumed servings, leftover mass by item, ratings, actual preparation time, and device usage.

In some embodiments, an artificial intelligence (AI) model is implemented as one or more scoring, ranking, and/or optimization models executed by the processing device. A non-limiting example computes a utility score for candidate food items using features derived from perishability, user preferences, device constraints, budget, and predicted waste risk. The model selects one or more food items subject to constraints specified by meal plan information and user variables. Learning logic updates preference parameters and/or weights using stored feedback and meal consumption information. The AI model may be realized as gradient-boosted trees, linear or integer programming with learned coefficients, a neural ranker, or rule-based heuristics; the selection and scheduling steps remain as described. Storage may be relational (SQL) or document-oriented (NoSQL). Device control may be indirect (user-facing instructions) and/or direct (smart-appliance APIs). These alternatives are within ordinary skill and do not depart from the claimed scope.

Unless otherwise specified, weights are in grams, volumes in milliliters, temperatures in degrees Celsius, and times in ISO-8601 timestamps or durations. A “time period” denotes an elapsed duration (for example, 24 hours, 48 hours, or one week) used to trigger scheduled updates.

In one embodiment, the processing device retrieves meal plan information for at least one user from the storage device by executing a query over records describing a plurality of meals and corresponding mealtimes. Retrieval may be time-triggered at a predetermined time of day and/or initiated in responsive to a user request, and the storage device returns a structured record set that includes, for each meal, at least a mealtime and one or more of servings, recipe reference, device constraints, preparation window, and thaw window.

In one embodiment, the processing device accesses at least one database comprising a plurality of food item information records. Each food item information record corresponds to a respective food item and may encode, without limitation, item identity, category, quantity, storage location, expiration data, and state. The database may be relational, key-value, document-oriented, or a combination thereof.

In one embodiment, the processing device executes at least one artificial intelligence model configured to process the plurality of food item information in view of the retrieved meal plan information. The model computes, for each candidate item, a utility score as a function of features including perishability, user preference fit, device compatibility, budget fit, and predicted waste risk, and selects at least one food item for a meal using at least one variable associated with the user, such as a dietary profile, calorie target, schedule availability, or equipment list, subject to the constraints of the meal plan information.

In one embodiment, the processing device generates machine-readable and human-readable instructions for creating the meal. The instructions may be represented as an ordered list of steps specifying ingredients, quantities, device parameters including temperature and time, sequencing dependencies, and cues to initiate or complete a step.

In one embodiment, the communication device transmits the generated instructions to at least one user-associated device, such as a smartphone or tablet, and in certain implementations to a compatible kitchen appliance via an available application programming interface. Transmission acknowledgments or delivery receipts may be recorded to ensure synchronization.

In one embodiment, the storage device stores the at least one variable associated with the user, including updates to dietary preferences, budget constraints, and equipment lists, and such stored variables are made available to subsequent executions of the model and planning logic.

In one embodiment, the processing device analyzes meal plan information to determine operational constraints, including preparation windows, device constraints, thaw requirements, and serving targets for an upcoming mealtime. In one embodiment, the processing device determines a preparation time for the meal by computing a critical path over a directed acyclic graph of meal preparation steps, the critical path including marination, thawing, cooking, resting, and assembly steps, each bounded by the preparation window of the target mealtime.

In one embodiment, the processing device filters the plurality of food items to identify at least one raw food item having a state equal to raw, sufficient available quantity, and compatibility with the computed preparation time and device constraints. In one embodiment, the processing device analyzes raw food item information using one or more criteria, including remaining shelf life, required thaw time, expected yield, allergen exclusion, device requirement, and portion coverage relative to the serving target.

In one embodiment, the processing device generates at least one processing instruction that converts the raw food item into a processed food item within the determined preparation time, the instruction specifying a process type, temperature, duration, and target doneness. In one embodiment, the processing device generates processed food item information, including a reference to the source raw item, process type, yield mass, storage state, and updated expiration. In one embodiment, the storage device stores the processed food item information in the database such that the corresponding food item information for the processed item includes the processed food item information.

In one embodiment, the processing device identifies a plurality of raw food items that satisfy meal plan constraints and inventory sufficiency. In one embodiment, the processing device analyzes raw item information for each identified item to compute features including perishability, preparation feasibility within the available window, repurpose potential, user preference fit, and allergen status.

In one embodiment, the processing device determines a priority for each raw food item by evaluating a priority function that weights the analyzed features according to learned or configured coefficients. In one embodiment, the processing device generates a numerical priority score for each raw food item and selects at least one raw food item from the plurality based on the priority score. The processing device also selects at least one additional food item for the meal using the user variables, the plurality of food item information, and the meal plan information.

In one embodiment, the processing device identifies a plurality of leftover food items by detecting items with a state equal to leftover and a positive remaining quantity, analyzes leftover food item information based on meal plan information, and determines a repurposability of each leftover food item for the target meal. Repurposability may be computed as a function of time to expiration, recipe coverage for derivative uses, complementarity with current inventory, and preparation burden. The selection of the at least one food item for the meal may be further based on the repurposability, thereby including at least one leftover food item where appropriate.

In one embodiment, responsive to creating the meal, the processing device updates the database to reflect decremented quantities of utilized items, state transitions corresponding to cooked or assembled items, and a record of the creation event with timestamp and device usage. The update is performed atomically to maintain inventory consistency.

In one embodiment, following consumption of the meal, the processing device obtains meal consumption information via user input and, in certain implementations, automated inference from served versus planned portions. In one embodiment, the processing device analyzes the meal consumption information to identify at least one leftover food item unconsumed in the meal and quantifies leftover mass and portions. In one embodiment, the processing device generates leftover food item information, including identity, quantity, storage location, and updated expiration, and updates the database to add such leftover records. The storage device stores the meal consumption information for learning and future planning.

In one embodiment, the processing device retrieves previous meal consumption information associated with at least one previous meal and determines a meal consumption pattern for the user. The pattern may encode acceptance rates by meal category and mealtime, leftover propensity by recipe family, and typical portion variances. The processing device uses the meal consumption pattern as an input feature or constraint during the subsequent selection of food items for future meals.

In one embodiment, the processing device updates the meal plan using the determined meal consumption pattern by adjusting at least one future meal information field for at least one future meal, including servings, side selections, thaw windows, or device assignments, to improve predicted adherence, reduce waste, and align with user preferences and constraints.

In one embodiment, the communication device receives feedback for a meal from at least one user device, the feedback including ratings and qualitative comments. The processing device analyzes the feedback to update preference vectors, waste-risk parameters, and model weights, and further updates the meal plan in light of the analyzed feedback.

In one embodiment, upon elapse of a configured time period, the processing device performs a scheduled update that analyzes the plurality of food item information and determines updates corresponding to one or more food items. The update may include modifying at least one parameter, such as expiration timestamps, quality scores, thaw-ready flags, and alert thresholds. Items crossing freshness or availability thresholds may trigger plan refreshes or notifications.

In some embodiments, the method includes constructing, using the processing device, a recipe graph and a task graph that encode step dependencies, appliance capacity constraints, and mealtime windows; computing, using the processing device, a critical path over the task graph; and producing, using the processing device, an assigned task graph that maps steps to at least one household member and to available devices to avoid contention. Further, a recipe graph refers to a directed graph whose nodes correspond to preparation and cooking steps and whose edges encode precedence constraints, and a task graph refers to the same graph augmented with resource annotations that specify device capacity and mealtime windows. Further, the processing device executes an algorithm that (i) builds the recipe graph from a recipe specification, (ii) augments each node with device requirements, estimated duration, and earliest start and latest finish times computed from a mealtime window, (iii) computes a critical path by longest-path analysis on an acyclic graph, and (iv) emits an assigned task graph by solving a resource-constrained assignment that maps each node to a household member and device while preventing overlapping use beyond device capacity. The system includes at least one processor programmed to execute the foregoing graph construction, scheduling, and assignment algorithms; at least one memory storing the graph data structures; and input/output interfaces to receive recipe specifications and device capabilities. The system produces concrete execution artifacts that govern real-world device usage and human assignments, thereby transforming planning into a resource-feasible cooking schedule.

In some embodiments, the method includes generating, using the processing device, a portion plan that allocates at least one selected food item between fresh and freezer states; assigning, using the processing device, thaw and cook dates associated with the portion plan; and generating, using the processing device, a thaw/cook schedule and a portion map, wherein the processing device generates day-of step sequences based on the thaw/cook schedule and the portion map. Further, a portion plan is a table that specifies, for each selected food item, a quantity allocated to immediate consumption and a quantity allocated to frozen storage; a portion map indexes those quantities to specific meals and dates; and a thaw/cook schedule specifies thaw start timestamps and cook start timestamps that conform to device availability windows. Further, the processing device calculates frozen yields using expected cooking loss factors and assigns thaw start times by back-calculating from cook start times given a thaw-time model parameterized by item mass and storage temperature; day-of-step sequences are produced by serializing the relevant nodes of the assigned task graph within the permissible windows. The system includes the programmed processor, memory storing portion records, and interfaces for generating user-or device-consumable instructions.

In some embodiments, the method includes updating, using the processing device, the at least one database with state transitions for food items used or produced according to the assigned task graph; detecting, using the processing device, at least one grocery gap; and generating, using the processing device, a grocery list synchronized to the portion plan and to the thaw/cook schedule. Further, the processing device records actual preparation times, step completions, and user ratings associated with the at least one instruction, and updates a preference model and waste-prediction parameters based on the recorded data for use in subsequent plan generation. Further, a state transition is a record indicating a change among raw, prepped, cooked, and leftover states with updated quantity and expiration; a grocery gap is a shortfall between required quantities for scheduled meals and on-hand inventory. Further, the processor executes database transactions that atomically decrement consumed quantities, create leftover entries, and compute gaps by comparing the portion plan against inventory; the grocery list enumerates items, units, and procurement deadlines derived from thaw dates. The system includes the processor executing the specified transactions and models, memory storing tables, and a communication interface to output the grocery list.

Further, in some embodiments, the selecting of the at least one food item comprises selecting at least one anchor protein according to a reuse and waste-reduction metric and performing, using the processing device, joint optimization over budget, diet, equipment, inventory, and schedule constraints to seed progression meal generation. Further, an anchor protein is a primary protein component planned to produce multiple derivative meals; the reuse and waste-reduction metric is a scalar objective that increases with predicted derivative coverage and decreases with predicted spoilage risk. Further, the processor solves a constrained optimization that maximizes the metric subject to nutrition, cost, device capacity, and calendar constraints, for example, via mixed-integer programming or heuristic beam search with feasibility checks. The system includes the processor programmed with the stated optimization routine and memory storing constraint matrices and coefficients.

In some embodiments, the method includes assigning, using the processing device, cooking and preparation steps to at least one household member based on skill level, availability, and device access, thereby balancing workload and enforcing device-safety constraints. Further, a skill level is a categorical or numeric capability indicator associated with a household member; availability is a time window during which the member can perform tasks; and device access is a permission set indicating which appliances the member may safely use. Further, the processor solves a bipartite matching between tasks and members that minimizes workload variance subject to required skills, availability overlap, and device-safety permissions; ties are broken by minimizing total makespan. The system includes the processor executing the matching algorithm and memory storing member profiles and permissions.

Further, in some embodiments, the portion plan implements an explicit fresh/freezer split with thaw timing that extends meals across multiple days while minimizing waste, and the processing device re-computes the thaw/cook schedule upon detecting an inventory change or a calendar change. Further, an inventory change is a detected delta in quantity or state records for a food item, and a calendar change is an edit to a mealtime window. Further, the processor monitors triggers and, upon detection, recomputes thaw start times and cook start times using the same models and constraints while preserving food safety times. The system includes the processor executing the re-scheduling routine and memory storing event triggers and thresholds.

Further, in some embodiments, the processing device identifies leftover food items and computes repurposability scores as planning objectives, and the processing device logs leftover records with quantity and updated expiration, and automatically proposes derivative meals that incorporate the leftover food items into a next planning cycle. Further, a repurposability score is a scalar function of time-to-expire, compatible recipes, and complementarity with current inventory. Further, the processor computes the score for each leftover and inserts the leftover as a candidate ingredient in the next selection round, subject to safety and nutrition constraints; proposed derivative meals are added to the meal plan information. The system includes the processor executing the scoring and selection routines and memory holding leftover indices.

In some embodiments, the method includes computing, using the processing device, a priority score for candidate food items using features comprising perishability, preparation feasibility within a preparation window, repurpose potential, preference fit, and allergen status; and selecting, using the processing device, a top K subset of the candidate food items consistent with mealtime constraints. Further, perishability is a function of remaining shelf life; preparation feasibility is a binary or probabilistic indicator that requires steps fit within the preparation window; and top K denotes the K highest scoring items under the priority score. Further, the processor normalizes feature values, applies learned weights to compute the score, and selects the subset while enforcing diet and allergen exclusions. The system includes the processor executing the scoring and selection routines, and memory storing features and weights.

In some embodiments, the method includes storing, using the storage device, food state transitions for each food item as records indicating transformations among raw, prepped, cooked, and leftover states with updated expirations; and referencing, using the processing device, the stored records by the portion plan and by a thaw/cook schedule during subsequent selection and execution. Further, each transition record includes the item identifier, the prior state, the new state, the quantity delta, and the computed expiration timestamp. Further, the processor writes transition records on completion of steps in the assigned task graph and reads those records when computing future allocations and thaw timings. The system includes the processor and storage device configured to perform the described read-modify-write operations.

In some embodiments, the method includes generating, using the processing device, a directed acyclic graph of steps that is parameterized by device capabilities and user skill; and partitioning, using the processing device, the directed acyclic graph into prep-day batch tasks and cook-day finishing tasks to reduce mealtime makespan and avoid appliance contention. Further, device capabilities are enumerated modes, capacities, and temperature ranges of the available appliances, and user skills. Further, the processor annotates each node with device and skill requirements and applies a partitioning heuristic that moves long-lead, device-agnostic tasks to a prep day while retaining time-sensitive finishing tasks on the cook day. Further, the system includes the processor executing the partitioning algorithm and memory storing annotated graphs.

Further, in some embodiments, the processing device produces day-of instructions parameterized by device capabilities corresponding to equipment on hand, including at least one mode selected from an air fryer mode and a rice cooker mode, and the processing device substitutes a compatible cooking path when a constrained device is unavailable. Further, a compatible cooking path is a sequence of steps that achieves the same doneness and safety thresholds using an alternative device and adjusted time-temperature parameters. Further, the processor selects a path from a library indexed by device capability vectors and scales time or temperature according to portion mass. The system includes the processor executing the instruction generation and substitution routines, and a memory storing device profiles.

Further, in some embodiments, the processing device uses leftover volumes and spoilage signals, in addition to user ratings, to update plan-generation parameters for a subsequent planning cycle. Further, a spoilage signal is an indication that a food item exceeded a freshness threshold without consumption. Further, the processor updates preference vectors and waste-risk coefficients via exponential smoothing or stochastic gradient updates using the observed leftover volumes and spoilage indicators. The system includes the processor executing the update rules and memory storing the parameters.

In some embodiments, the method includes generating, using the processing device, a grocery list aligned to the portion plan; and detecting, using the processing device, inventory gaps prior to scheduled thaw events to maintain continuity between planning, procurement, and execution. Further, alignment to the portion plan means the list enumerates items, units, and required-by dates computed from thaw start times; an inventory gap is a negative difference between required and on-hand quantities at the check time. Further, the processor simulates upcoming meals over a planning horizon, compares projected consumption with inventory, and issues the list with lead times sufficient for procurement. The system includes the processor executing the simulation and comparison routines and memory storing the portion plan and inventory records.

Further, in some embodiments, the processing device performs joint optimization of cost, time, and predicted waste under diet, equipment, and schedule constraints to rank anchor selections and to produce a task-graph seed for subsequent assignment. Further, a task-graph seed is an initial feasible set of tasks and temporal placements that satisfies constraints prior to resource assignment. Further, the processor formulates a multi-objective function and solves it using weighted sums or Pareto ranking subject to linearized constraints, yielding a seed that is subsequently expanded into the assigned task graph. The system includes the processor executing the optimization algorithm and memory storing the objective coefficients.

In some embodiments, the method includes reflowing, using the processing device, the meal plan upon detecting that a mealtime is skipped or that the inventory changes, by re-computing the portion plan and the thaw/cook schedule, and by updating the assigned task graph. Further, reflowing is a recomputation that preserves already completed steps and reassigns remaining steps to maintain feasibility. Further, the processor marks affected nodes as incomplete, resolves the schedule under revised windows and inventory, and issues updated instructions. The system includes the processor executing the re-planning routine and memory storing state checkpoints.

In some embodiments, the method includes flagging, using the processing device, food items nearing expiration; and elevating, using the processing device, a selection priority for the flagged food items within the task graph to reduce spoilage while maintaining device capacity constraints. Further, nearing expiration is defined as a remaining shelf life below a threshold; elevating selection priority increases ranking score terms for flagged items. Further, the processor computes remaining shelf life from timestamps, applies a threshold, and adjusts scores while ensuring that device capacity and mealtime windows remain satisfied. The system includes the processor executing the thresholding and scoring adjustments, and memory storing expiration data.

Further, in some embodiments, the processing device uses actual portion sizes to dynamically adjust cook times for a recipe step included in the at least one instruction and records, using the processing device, the adjusted cook time for use in a subsequent planning cycle. Further, actual portion size is the measured mass or count at execution time; dynamic adjustment scales a baseline time according to a heat-transfer model or empirically derived scaling rule. Further, the processor reads the portion size from user input or a connected scale, computes an adjusted time, updates the instruction, and stores the measured time for model refinement. The system includes the processor executing the scaling and recording routines, and memory storing baseline and adjusted times.

In certain embodiments, the alleged abstract idea of “planning meals and selecting food items for users” is expressly integrated into a practical application by a multi-module architecture that transforms raw inventory and schedule inputs into day-by-day, device-aware execution artifacts and updated inventory states. A user profile and inventory module normalizes household data; a planning and optimization engine constructs a recipe graph and ranks anchor candidates; a progression meal generator outputs derivative meals and a portion plan with fresh/freezer splits and thaw/cook dates; a storage planner updates inventory and detects grocery gaps; an execution and instruction module emits member-and device-specific step sequences and records actuals; and a feedback and learning loop updates preference and waste models for the next cycle, thereby operationalizing meal planning as a closed-loop system that produces tangible execution outputs and inventory state transitions rather than a mere recommendation list.

In a representative technical solution, the system addresses the concrete problem of perishability-driven waste under limited appliance capacity and variable household schedules by selecting one or more “anchor” proteins and generating a multi-day progression of derivative meals that are jointly optimized across diet, budget, equipment, inventory, and schedule constraints. The anchor meal selector chooses anchors by a reuse/waste-reduction metric, the progression generator computes yields and allocates portions to immediate use or freezing, and thaw dates and cook events are scheduled to match appliance availability, thereby reducing spoilage while balancing load on appliances and household members.

To solve the technical problem of converting unstructured pantry snapshots into actionable, time-bounded cooking steps, the execution and instruction module synthesizes day-of step sequences parameterized by member skill and available devices, logs step completions and actual prep times, and returns these measurements to the learning loop. The task distributor resolves contention for constrained appliances by assigning steps according to appliance access and member availability, and the storage planner generates a thaw/cook schedule and grocery list consistent with the portion plan, thus closing the loop between planning and physical execution.

The inventive concept includes an anchor-to-progression planning framework that explicitly models food state transitions (raw—prepped—cooked—leftover) and integrates a storage-aware allocation with scheduled thawing so that the same bulk preparation drives distinct, fresh-assembled meals over several days. Unlike conventional static meal lists, the system quantifies repurposability and leftover yields, writes those back into inventory with updated expirations, and automatically proposes derivative recipes for the next day, which is then reflected in the subsequent execution plan.

Additional elements that integrate the idea into practice include (i) a perishability-and preference-driven prioritization pipeline for proteins and other items; (ii) a portion plan that specifies immediate serving quantities versus frozen reserves with explicit thaw-by dates; (iii) a thaw/cook schedule and grocery list emitted to downstream modules; and (iv) continuous parameter updates from user ratings, leftover volumes, and step-time measurements that recondition the next planning pass. These elements collectively ensure that the claimed selection and planning are inseparably tied to concrete inventory updates, scheduled device usage, and future plan modification, thereby effectuating a practical application beyond mere information processing.

In some embodiments, the technical approach further integrates leftover tracking and repurposing as a first-class planning objective: after each meal, unused portions are logged back into inventory as leftovers with quantity, location, and days-to-expire; the system proposes next-day derivative meals that incorporate these leftovers; and the plan is automatically reflowed, thereby minimizing waste and stabilizing grocery demand against schedule changes. The technical improvement lies in the explicit modeling of leftover state, its incorporation into the next-day selection, and the binding of those choices to updated step sequences and thaw schedules.

The system also provides a concrete solution to the problem of variable member availability and skill heterogeneity by algorithmically distributing cooking and prep steps across the household. Assignments are computed with awareness of appliance constraints and safe operation levels, and day-of instructions are individualized accordingly; the result is a computable, resource-feasible execution plan that materially alters when, where, and by whom steps are performed, and not merely what meals are suggested.

In embodiments directed to enablement for the “AI model” limitations, the planning engine builds a context using inventory, equipment, and user constraints; ranks anchor candidates; and, together with the progression generator, computes yields and schedules that respect appliance capacity and mealtime windows. The model's outputs are not end-user displays alone but concrete artifacts—an assigned task graph, portion maps, and thaw/cook timelines—that drive and record physical operations in the kitchen and persist as inventory state changes.

The feedback and learning loop supplies an additional element, integrating the abstract idea into practical application by continuously updating preference models and waste-prediction parameters from measured prep times, completion status, ratings, and leftover volumes. These updated parameters directly feed the next planning cycle, altering anchor selection, portion sizing, and storage allocation so that the system's behavior changes as a function of observed execution data rather than static rules.

The technical problems addressed by the claims, including avoiding spoilage under changing schedules, meeting device capacity constraints, and reducing total prep time without sacrificing variety, are solved by joint optimization across budget, diet, equipment, inventory, and schedule, combined with explicit fresh/freezer splitting and thaw timing that spreads preparation across days. By emitting a grocery list aligned with the computed portion plan and detecting inventory gaps, the system ensures resource-feasible execution and continuity between planning, procurement, and cooking.

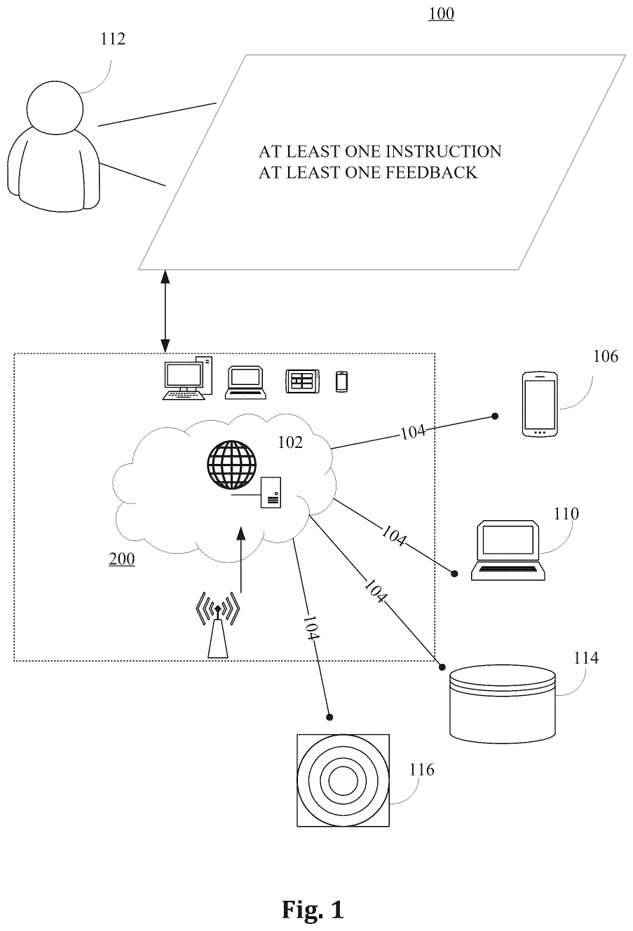

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

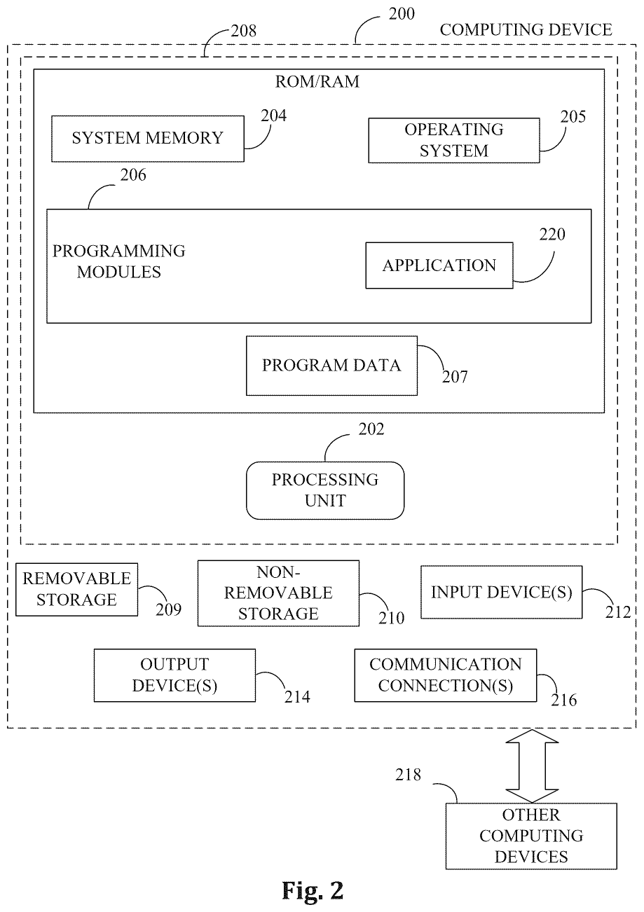

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

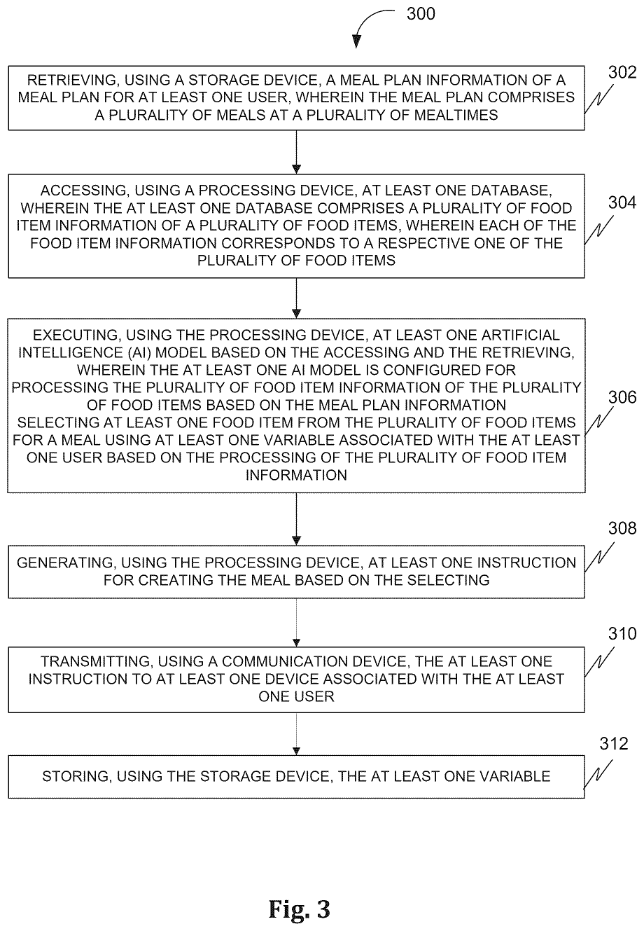

FIG. 3 illustrates a flowchart of a method 300 of facilitating planning of meals for users, in accordance with some embodiments. Accordingly, the method 300 may include a step 302 of retrieving, using a storage device 802, a meal plan information of a meal plan for one or more users. Further, the meal plan includes two or more meals at two or more mealtimes. Further, the method 300 may include a step 304 of accessing, using a processing device 804, one or more databases. Further, the one or more databases include two or more food item information of two or more food items. Further, each of the food item information corresponds to a respective one of the two or more food items. Further, the method 300 may include a step 306 of executing, using the processing device 804, one or more Artificial Intelligence (AI) models based on the accessing and the retrieving. Further, the one or more AI models may be configured for processing the two or more food item information of the two or more food items based on the meal plan information. Further, the one or more AI models may be configured for selecting one or more food items from the two or more food items for a meal using one or more variables associated with the one or more users based on the processing of the two or more food item information. Further, the method 300 may include a step 308 of generating, using the processing device 804, one or more instructions for creating the meal based on the selecting. Further, the method 300 may include a step 310 of transmitting, using a communication device 806, the one or more instructions to one or more devices associated with the one or more users. Further, the method 300 may include a step 312 of storing, using the storage device 802, the one or more variables.

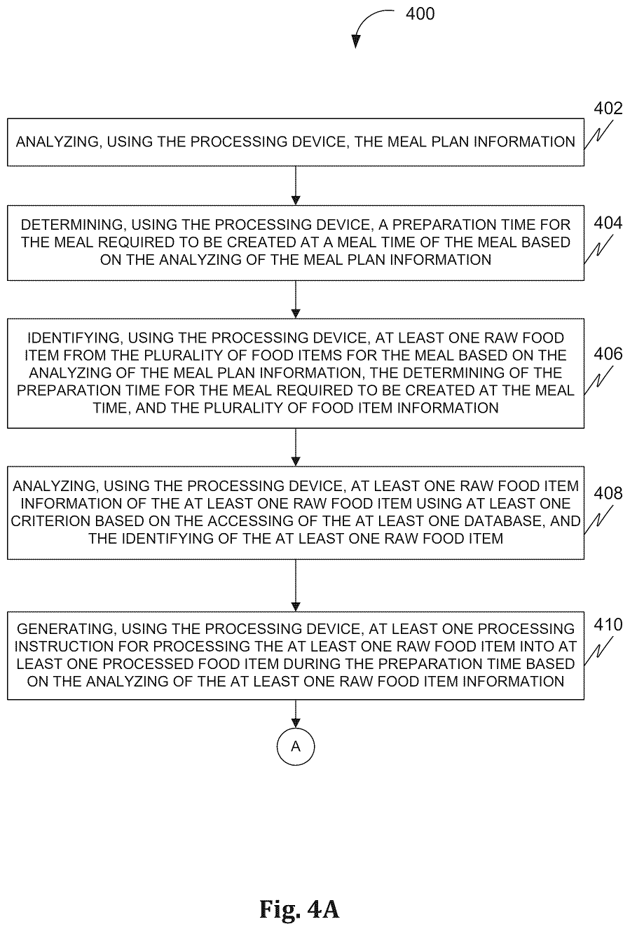

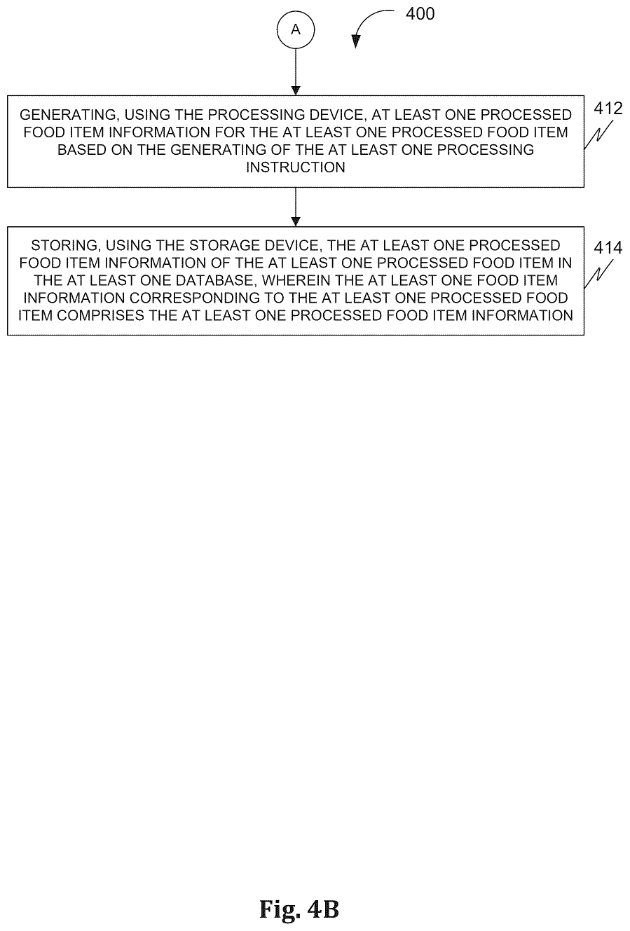

FIG. 4A and FIG. 4B illustrate a flowchart of a method 400 of facilitating planning of meals for users including generating, using the processing device 804, at least one processed food item information for the at least one processed food item, in accordance with some embodiments. Further, in some embodiments, the method 400 further may include a step 402 of analyzing, using the processing device 804, the meal plan information. Further, in some embodiments, the method 400 further may include a step 404 of determining, using the processing device 804, a preparation time for the meal required to be created at a meal time of the meal based on the analyzing of the meal plan information. Further, in some embodiments, the method 400 further may include a step 406 of identifying, using the processing device 804, one or more raw food items from the two or more food items for the meal based on the analyzing of the meal plan information, the determining of the preparation time for the meal required to be created at the meal time, and the two or more food item information. Further, in some embodiments, the method 400 further may include a step 408 of analyzing, using the processing device 804, one or more raw food item information of the one or more raw food items using one or more criteria based on the accessing of the one or more databases, and the identifying of the one or more raw food items. Further, in some embodiments, the method 400 further may include a step 410 of generating, using the processing device 804, one or more processing instructions for processing the one or more raw food items into one or more processed food items during the preparation time based on the analyzing of the one or more raw food item information. Further, in some embodiments, the method 400 further may include a step 412 of generating, using the processing device 804, one or more processed food item information for the one or more processed food items based on the generating of the one or more processing instructions. Further, in some embodiments, the method 400 further may include a step 414 of storing, using the storage device 802, the one or more processed food item information of the one or more processed food items in the one or more databases. Further, the one or more food item information corresponding to the one or more processed food items includes the one or more processed food item information.

Further, in some embodiments, the one or more AI models may be further configured for identifying two or more raw food items from the two or more food items based on the processing of the two or more food item information. Further, the one or more AI models may be further configured for analyzing two or more raw food item information comprised in the two or more food item information. Further, the one or more AI models may be further configured for determining a priority of each of the two or more raw food items based on the analyzing of the two or more food item information. Further, the one or more AI models may be further configured for generating a priority score for the priority of each of the two or more raw food items based on the priority of each of the two or more food items. Further, the one or more food items may include one or more raw food items and one or more additional food items. Further, the selecting of the one or more food items may include selecting the one or more raw food items for the meal using the one or more variables associated with the one or more users based on the two or more food item information, and the meal plan information. Further, the selecting of the one or more food items may include selecting the one or more additional food items for the meal using the one or more variables associated with the one or more users based on the two or more food item information, and the meal plan information. Further, the selecting of the one or more raw food items includes selecting the one or more raw food items from the two or more raw food items based on the priority score of each of the two or more raw food items.

Further, in some embodiments, the one or more AI models may be further configured for identifying two or more leftover food items from the two or more food items based on the two or more food item information. Further, the one or more AI models may be further configured for analyzing two or more leftover food item information of the two or more leftover food items based on the meal plan information. Further, the one or more AI models may be further configured for determining a repurposability of each of the two or more leftover food items for the meal based on the analyzing of the two or more leftover food item information. Further, the selecting of the one or more food items from the two or more food items for the meal may be further based on the repurposability of each of the two or more leftover food items. Further, the one or more food items further include one or more leftover food items of the two or more leftover food items.

In some embodiments, the method 300 may further include updating, using the processing device 804, the one or more databases after the creating of the meal. Further, the updating of the one or more databases includes updating the one or more food item information associated with the one or more food items.

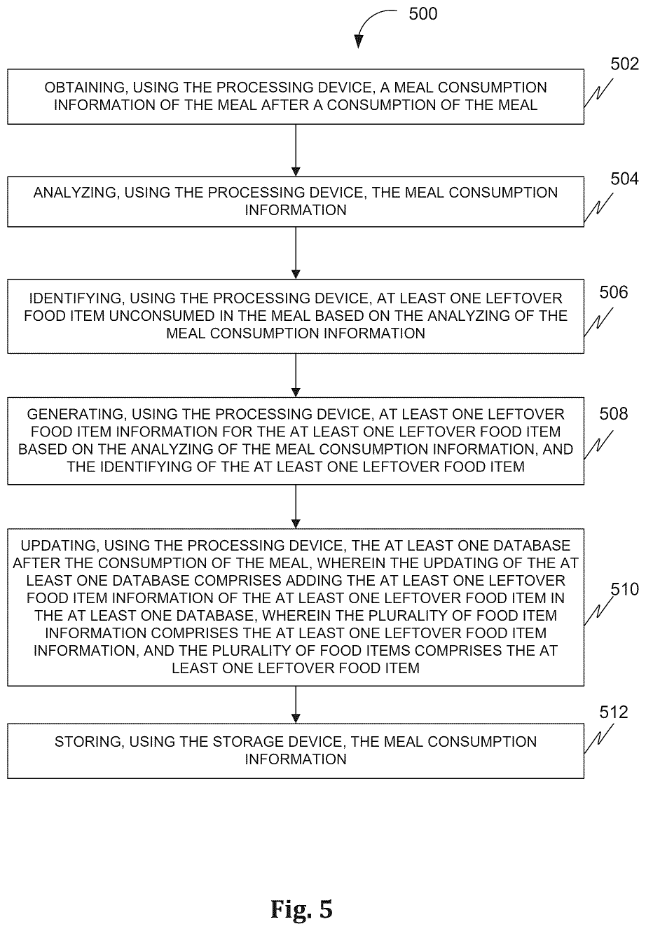

FIG. 5 illustrates a flowchart of a method 500 of facilitating planning of meals for users including updating, using the processing device 804, the at least one database after the consumption of the meal, in accordance with some embodiments. Further, in some embodiments, the method 500 further may include a step 502 of obtaining, using the processing device 804, a meal consumption information of the meal after a consumption of the meal. Further, in some embodiments, the method 500 further may include a step 504 of analyzing, using the processing device 804, the meal consumption information. Further, in some embodiments, the method 500 further may include a step 506 of identifying, using the processing device 804, one or more leftover food items unconsumed in the meal based on the analyzing of the meal consumption information. Further, in some embodiments, the method 500 further may include a step 508 of generating, using the processing device 804, one or more leftover food item information for the one or more leftover food items based on the analyzing of the meal consumption information, and the identifying of the one or more leftover food items. Further, in some embodiments, the method 500 further may include a step 510 of updating, using the processing device 804, the one or more databases after the consumption of the meal. Further, the updating of the one or more databases includes adding the one or more leftover food item information of the one or more leftover food items in the one or more databases. Further, the two or more food item information includes the one or more leftover food item information, and the two or more food items includes the one or more leftover food items. Further, in some embodiments, the method 500 further may include a step 512 of storing, using the storage device 802, the meal consumption information.

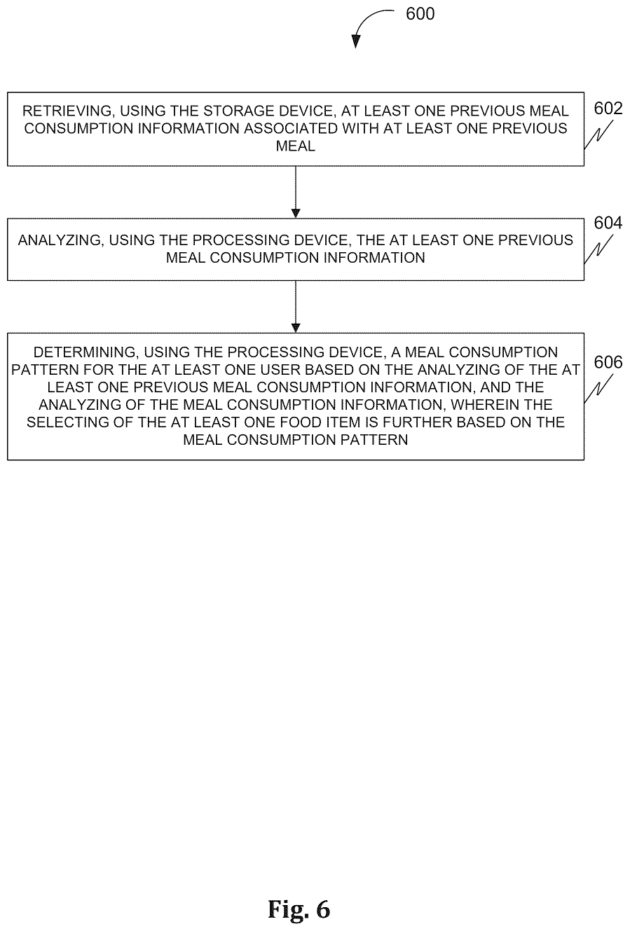

FIG. 6 illustrates a flowchart of a method 600 of facilitating planning of meals for users including determining, using the processing device 804, a meal consumption pattern for the at least one user, in accordance with some embodiments. Further, in some embodiments, the method 600 further may include a step 602 of retrieving, using the storage device 802, one or more previous meal consumption information associated with one or more previous meals. Further, in some embodiments, the method 600 further may include a step 604 of analyzing, using the processing device 804, the one or more previous meal consumption information. Further, in some embodiments, the method 600 further may include a step 606 of determining, using the processing device 804, a meal consumption pattern for the one or more users based on the analyzing of the one or more previous meal consumption information, and the analyzing of the meal consumption information. Further, the selecting of the one or more food items may be further based on the meal consumption pattern.

In some embodiments, the method 300 may further include updating, using the processing device 804, the meal plan based on the meal consumption pattern. Further, the updating of the meal plan includes updating one or more future meal information of one or more future meals of the two or more meals.

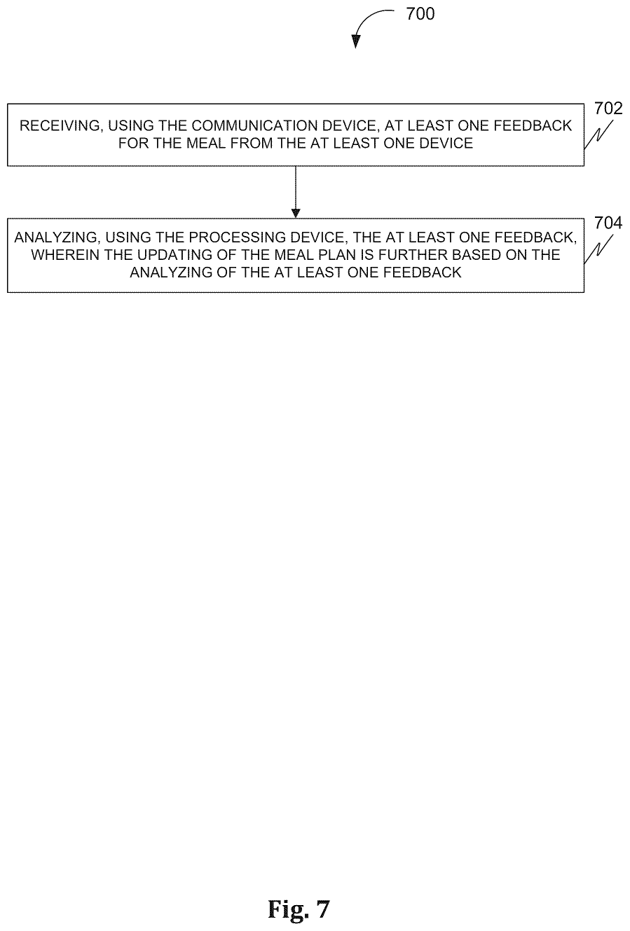

FIG. 7 illustrates a flowchart of a method 700 of facilitating planning of meals for users, including analyzing, using the processing device 804, the at least one feedback, in accordance with some embodiments. Further, in some embodiments, the method 700 further may include a step 702 of receiving, using the communication device 806, one or more feedback for the meal from the one or more devices. Further, in some embodiments, the method 700 further may include a step 704 of analyzing, using the processing device 804, the one or more feedbacks. Further, the updating of the meal plan may be further based on the analyzing of the one or more feedback.

In some embodiments, the method 300 may further include updating, using the processing device 804. the one or more databases after an elapse of a time period. Further, the updating of the one or more databases may include analyzing the two or more food item information of the two or more food items after the elapse of the time period. Further, the updating of the one or more databases may include determining an update corresponding to one or more of the two or more food items based on the analyzing of the two or more food item information, and the time period. Further, the updating of the one or more databases may include modifying one or more parameters comprised in one or more of the two or more food item information associated with one or more of the two or more food items.

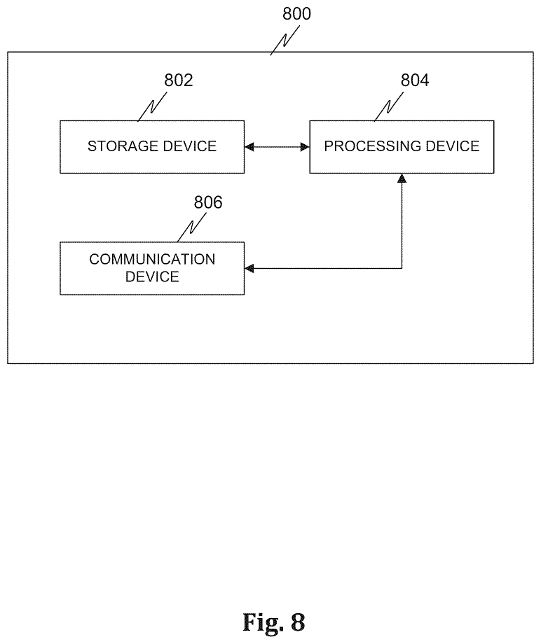

FIG. 8 illustrates a block diagram of a system 800 of facilitating planning of meals for users, in accordance with some embodiments. Accordingly, the system 800 may include a storage device 802. Further, the storage device 802 may be configured for retrieving a meal plan information of a meal plan for one or more users. Further, the meal plan includes two or more meals at two or more mealtimes. Further, the system 800 may include a processing device 804 communicatively coupled with the storage device 802. Further, the processing device 804 may be configured for accessing one or more databases. Further, the one or more databases include two or more food item information of two or more food items. Further, each of the food item information corresponds to a respective one of the two or more food items. Further, the processing device 804 may be configured for executing one or more Artificial Intelligence (AI) models based on the accessing and the retrieving. Further, the one or more AI models may be configured for processing the two or more food item information of the two or more food items based on the meal plan information. Further, the one or more AI models may be configured for selecting one or more food items from the two or more food items for a meal using one or more variables associated with the one or more users based on the processing of the two or more food item information. Further, the system 800 may include a communication device 806 communicatively coupled with the processing device 804. Further, the communication device 806 may be configured for transmitting the one or more instructions to one or more devices associated with one or more users.

Further, in some embodiments, the processing device 804 may be further configured for analyzing the meal plan information. Further, the processing device 804 may be further configured for determining a preparation time for the meal required to be created at a meal time of the meal based on the analyzing of the meal plan information. Further, the processing device 804 may be further configured for identifying one or more raw food items from the two or more food items for the meal based on the analyzing of the meal plan information, the determining of the preparation time for the meal required to be created at the meal time, and the two or more food item information. Further, the processing device 804 may be further configured for analyzing one or more raw food item information of the one or more raw food items using one or more criteria based on the accessing of the one or more databases, and the identifying of the one or more raw food items. Further, the processing device 804 may be further configured for generating one or more processing instructions for processing the one or more raw food items into one or more processed food items during the preparation time based on the analyzing of the one or more raw food item information. Further, the processing device 804 may be further configured for generating one or more processed food item information for the one or more processed food items based on the generating of the one or more processing instructions. Further, the storage device 802 may be further configured for storing the one or more processed food item information of the one or more processed food items in the one or more databases. Further, the one or more food item information corresponding to the one or more processed food items includes the one or more processed food item information.

Further, in some embodiments, the one or more AI models may be further configured for identifying two or more raw food items from the two or more food items based on the processing of the two or more food item information. Further, the one or more AI models may be further configured for analyzing two or more raw food item information comprised in the two or more food item information. Further, the one or more AI models may be further configured for determining a priority of each of the two or more raw food items based on the analyzing of the two or more food item information. Further, the one or more AI models may be further configured for generating a priority score for the priority of each of the two or more raw food items based on the priority of each of the two or more food items. Further, the one or more food items may include one or more raw food items and one or more additional food items. Further, the selecting of the one or more food items may include selecting the one or more raw food items for the meal using the one or more variables associated with the one or more users based on the two or more food item information, and the meal plan information. Further, the selecting of the one or more food items may include selecting the one or more additional food items for the meal using the one or more variables associated with the one or more users based on the two or more food item information, and the meal plan information. Further, the selecting of the one or more raw food items includes selecting the one or more raw food items from the two or more raw food items based on the priority score of each of the two or more raw food items.

Further, in some embodiments, the one or more AI models may be further configured for identifying two or more leftover food items from the two or more food items based on the two or more food item information. Further, the one or more AI models may be further configured for analyzing two or more leftover food item information of the two or more leftover food items based on the meal plan information. Further, the one or more AI models may be further configured for determining a repurposability of each of the two or more leftover food items for the meal based on the analyzing of the two or more leftover food item information. Further, the selecting of the one or more food items from the two or more food items for the meal may be further based on the repurposability of each of the two or more leftover food items. Further, the one or more food items further include one or more leftover food items of the two or more leftover food items.

In some embodiments, the processing device 804 may be further configured for updating the one or more databases after the creating of the meal. Further, the updating of the one or more databases includes updating the one or more food item information associated with the one or more food items.

Further, in some embodiments, the processing device 804 may be further configured for obtaining a meal consumption information of the meal after a consumption of the meal. Further, the processing device 804 may be further configured for analyzing the meal consumption information. Further, the processing device 804 may be further configured for identifying one or more leftover food items unconsumed in the meal based on the analyzing of the meal consumption information. Further, the processing device 804 may be further configured for generating one or more leftover food item information for the one or more leftover food items based on the analyzing of the meal consumption information, and the identifying of the one or more leftover food items. Further, the processing device 804 may be further configured for updating the one or more databases after the consumption of the meal. Further, the updating of the one or more databases includes adding the one or more leftover food item information of the one or more leftover food items in the one or more databases. Further, the two or more food item information includes the one or more leftover food item information, and the two or more food items includes the one or more leftover food items. Further, the storage device 802 may be further configured for storing the meal consumption information.

Further, in some embodiments, the storage device 802 may be further configured for retrieving one or more previous meal consumption information associated with one or more previous meals. Further, the processing device 804 may be further configured for analyzing the one or more previous meal consumption information. Further, the processing device 804 may be further configured for determining a meal consumption pattern for the one or more users based on the analyzing of the one or more previous meal consumption information, and the analyzing of the meal consumption information. Further, the selecting of the one or more food items may be further based on the meal consumption pattern.

In some embodiments, the processing device 804 may be further configured for updating the meal plan based on the meal consumption pattern. Further, the updating of the meal plan includes one or more future meal information of one or more future meals of the two or more meals.

In some embodiments, the communication device 806 may be further configured for receiving one or more feedback for the meal from the one or more devices. Further, the processing device 804 may be further configured for analyzing the one or more feedback. Further, the updating of the meal plan may be further based on the analyzing of the one or more feedback.

Further, in some embodiments, the processing device 804 may be further configured for updating the one or more databases after an elapse of a time period. Further, the updating of the one or more databases may include analyzing the two or more food item information of the two or more food items after the elapse (i.e., lapse) of the time period. Further, the updating of the one or more databases may include determining an update corresponding to one or more of the two or more food items based on the analyzing of the two or more food item information, and the time period. Further, the updating of the one or more databases may include modifying one or more parameters comprised in one or more of the two or more food item information associated with one or more of the two or more food items.

In some embodiments, the two or more food item information represents one or more of a food type, a food quantity, a food storage location, and a food expiration date of the two or more food items.

In some embodiments, the one or more criteria include one or more perishability values, an available quantity, a household preference, a dietary restriction, and a prior wastage of the one or more raw food items.

In some embodiments, the one or more feedback includes one or more of a user rating. Further, the one or more user ratings may be based on one or more of a taste, a preparation effort, and a user family's approval of the meal.

In some embodiments, the one or more variables associated with the one or more users represent one or more of a household size and a dietary preference of the one or more users.

In some embodiments, the updating of the least one future meal information of one or more future meals includes updating one or more of a portion size, a recipe, and a cooking style preferences of the one or more future meals.

In some embodiments, the determining of the repurposability of each of the two or more leftover food items includes determining one or more compatible recipes for the each of the two or more leftover food items.

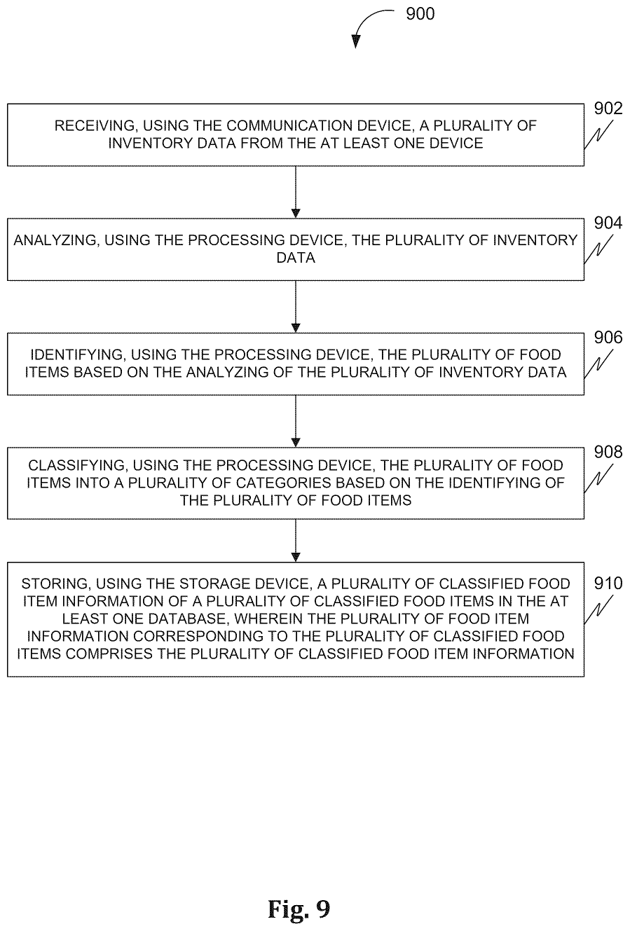

FIG. 9 illustrates a flowchart of a method 900 of facilitating planning of meals for users including classifying, using the processing device 804, the plurality of food items into a plurality of categories, in accordance with some embodiments. Further, in some embodiments, the method 900 further may include a step 902 of receiving, using the communication device 806, two or more inventory data from the one or more devices. Further, in some embodiments, the method 900 further may include a step 904 of analyzing, using the processing device 804, the two or more inventory data. Further, in some embodiments, the method 900 further may include a step 906 of identifying, using the processing device 804, the two or more food items based on the analyzing of the two or more inventory data. Further, in some embodiments, the method 900 further may include a step 908 of classifying, using the processing device 804, the two or more food items into two or more categories based on the identifying of the two or more food items. Further, in some embodiments, the method 900 further may include a step 910 of storing, using the storage device 802, two or more classified food item information of two or more classified food items in the one or more databases. Further, the two or more food item information corresponding to the two or more classified food items includes the two or more classified food item information.

In some embodiments, the two or more inventory data represent the two or more food item information of the two or more food items. Further, the two or more inventory data include one or more of a food inventory data, kitchen inventory data, and a recipe collection.

In some embodiments, the two or more categories include one or more of a protein category, a produce category, a pantry staple category, a frozen category, and a garden source category.

In some embodiments, the method 400 may further include calculating, using the processing device 804, one or more optimal portion sizes of the one or more raw food items using the one or more variables associated with the one or more users based on the analyzing of the one or more raw food item information of the one or more raw food items.

In some embodiments, the one or more processing instructions represent one or more processing methods of the one or more raw food items. Further, the one or more processing methods include one or more of a marination method, a partial cooking method, a full cooking method, a seasoning method, and a freezing method.

FIG. 10A and FIG. 10B illustrate a flowchart of a method 1000 of collecting a plurality of user inputs, in accordance with some embodiments. Further, the method 1000 includes generating a manual subscription user setup 1002. Further, the method 1000 includes receiving a manual initial input 1002 from the one or more devices. Further, the manual initial input 1002 represents one or more personal aspects of the one or more users 1012 and the one or more users'home life 1052, the food inventory 1008, the kitchen inventory 1056, the recipe collection 1064, and the equipment 1068. Further, the method 1000 includes receiving an input photo of an item and a receipt 1006 from the one or more devices. Further, the input photos of an item and a receipt 1006 represent an inventory of food at the home 1010, an inventory of one or more kitchen items at the home 1056, and a collection of one or more recipes at the home 1064. Further, an Artificial Intelligence engine (AI) catalogs the food inventory 1010, the kitchen inventory 1056, and the recipe collection 1064. Further, the AI engine categorizes the food inventory into a freezer, a fridge, a garden, and a pantry 1050. Further, the one or more personal aspects of the one of more users 1012 comprises an age and activity level 1032, one or more DIY items 1036, a cuisine, a DIY and one or more ingredient preferences 1034, a health 1038, a personal care 1026, a schedule 1042, one or more activities 1044, one or more ingredient preferences 1040, an equipment 1048, and one or more skills 1046. Further, the one or more aspects of the user's home life 1052 comprises one or more DIY items 1014, a financial wellness 1022, a home care 1024, a pet care 1028, a schedule 1030, a manual 1016, and one or more DIY items 1020. Further, the method 1000 represents a household management system. Further, the household management system comprises one or more of an initial input block, an AI engine, a progression cooking block, a user interface block, an output block, a weekly input block, an app block, and a subscription block 1054. Further, the 1000 receives a manual initial input home kitchen inventory 1058 from the one or more devices. Further, the manual initial input home kitchen inventory 1058 comprises one or more equipment, gadgets, and utensils. Further, the method includes receiving an input photo of a recipe 1062 from the one or more user devices. Further, the household management system updates the user's recipe collection 1064 based on the input photo of the recipe 1062. Further, the method 1000 includes receiving a manual initial input home recipe collection 1066 from the one or more devices.

FIG. 11 illustrates a flowchart of a method 1100 of generating a guidance information, in accordance with some embodiments. Further, the method 1100 includes generating guidance information. Further, the guidance information comprises one or more advanced lessons, one or more chef tutorials, one or more equipment and gadget instructions, a food science education, a latest technology food news, and a nutritionist 1102. Further, the guidance information 1100 further comprises one or more cooking lessons, one or more chef tutorials, one or more equipment instructions, a latest technology food news and nutrition, a food science education 1102, and one or more guest chef recipes 1116. Further, the food education comprises food safety 1108, general safety 1110, sustainability 1114, and perishability 1112 of the two or more food items. Further, the one or more cooking lessons comprise basic baking and cooking 1124 and cooking conversions and measurements 1106. Further, the guidance information further comprises recipe reviews 1122, a food donation information 1120, and one or more recipes of a community 1118.

FIG. 12 illustrates a flowchart of a method 1200 of collecting at least one weekly user input, in accordance with some embodiments. Further, the method 1200 includes receiving the user's weekly information 1206 manually from the one or more devices. Further, the user's weekly information 1206 represents one or more aspects of the user's week. Further, the AI-generated output is based on the user's weekly information 1206. Further, the method 1200 includes receiving one or more photos of expired food 1202. Further, the method 1200 includes updating the home recipe collection using AI 1204 based on one or more photos. Further, the user's weekly information 1206 represents one or more of an expired food, family information, grocery sales, inventory, schedule 1208, one or more review recipes 1214, an available time 1210, cooking, meal prepping, and shopping 1216, and a visitor's information 1212. Further, the visitor's information comprises age, allergies, cuisine, ingredient, preferences, and spice tolerance level 1218.

FIG. 13A and FIG. 13B illustrate a flowchart of a method 1300 of generating an AI output, in accordance with some embodiments. Further, the method 1300 includes generating an AI output. Further, the AI output comprises a daily task information 1304, a meal preparation weekly information 1318, a meal plans weekly information 1322, a grocery list weekly information 1316, a fresh meal assembly information 1330, a grocery order 1302, and a home calendar and monthly report information 1326. Further, the daily tasks information 1304 comprises a daily tasks list 1306 and a continuous task list 1308 for the one or more users. Further, the meal preparation weekly information comprises meal preparation instructions for the one or more users 1310. Further, the meal plans weekly information 1322 comprises a weekly menu calendar for home 1324 and a daily meal plan list for the one or more users 1312. Further, modifying draft 1320 based on the AI output. Further, the grocery list weekly information 1316 comprises a weekly grocery list for the one or more users 1314. Further, the fresh meal assembly information 1330 comprises weekly assembly instructions for the one or more users 1332. Further, the home calendar and monthly report information 1326 comprises financial information, a schedule of the user, and pet care 1328.

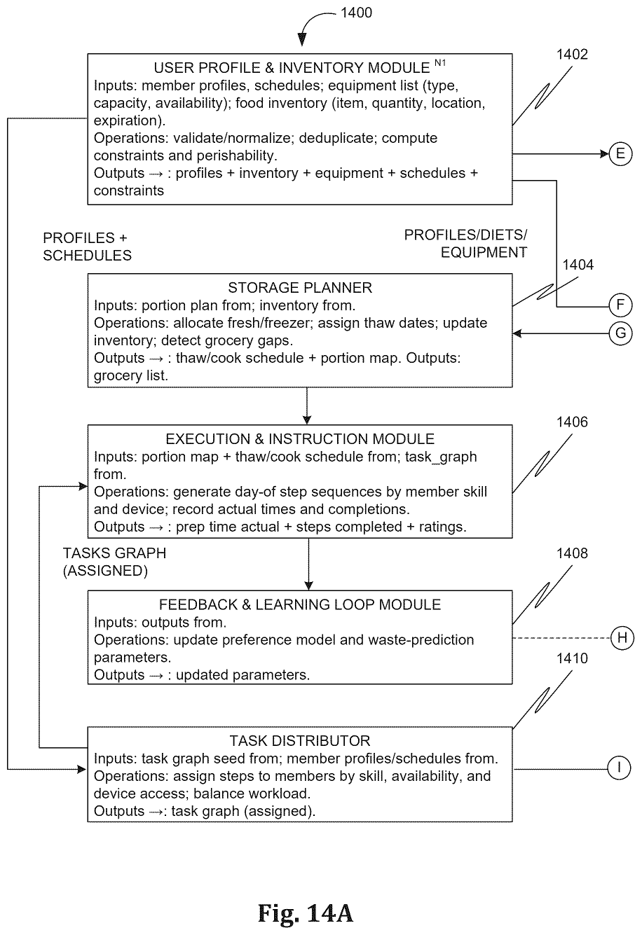

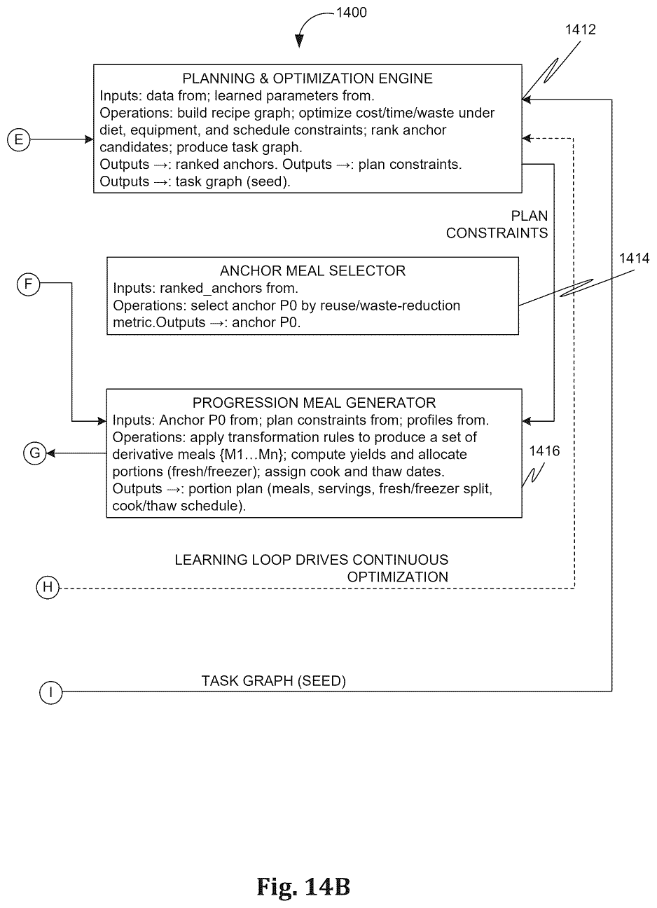

FIG. 14A and FIG. 14B illustrate a system architecture 1400 of facilitating planning of meals for users, in accordance with some embodiments. Further, in some embodiments, the system architecture 1400 includes a user profile and inventory module. Further, the user profile and inventory module 1402 is configured for collecting household data. Further, the household data comprises one or more of a household profile, a schedule, an equipment list, and a food inventory. Further, the user profile and inventory module 1402 is configured for validating and normalizing the inventory data. Further, in some embodiments, the system architecture 1400 further includes a planning and optimization engine 1412. Further, the planning and optimization engine 1412 is configured for building a recipe graph and optimizing one or more of a cost, a time, and a waste under one or more of a diet, an equipment, and a schedule constraint. Further, the planning and optimization engine 1412 is configured for ranking one or more anchor candidates and producing a task graph seed. Further, in some embodiments, the system architecture 1400 further includes an anchor meal selector 1414. Further, the anchor meal selector 1414 is configured for selecting one or more anchor proteins using a waste-reduction metric. Further, in some embodiments, the system architecture 1400 further includes a progression meal generator 1416. Further, the progression meal generator 1416 is configured for transforming one or more anchor meals into one or more derivative meals. Further, in some embodiments, the system architecture 1400, further includes a storage planner 1404. Further, the storage planner 1404 is configured for assigning one or more thaw dates. Further, the storage planner 1404 is further configured for updating an inventory and detecting one or more grocery gaps. Further, in some embodiments, the system architecture 1400 further comprises an execution and instruction module 1406. Further, the execution and instruction module 1406 is configured for generating one or more day-to-day preparation instructions based on one or more skills of the one or more members and an availability of the one or more devices. Further, the execution and instruction module 1406 is configured for recording one or more of a preparation time, a step completion, and a rating. Further, in some embodiments, the system architecture 1400 further includes a feedback and learning loop module 1408. Further, the feedback and learning loop module 1408 is configured for updating a user preference and a waste-prediction model based on an execution and instruction result. Further, in some embodiments, the system architecture 1400 further includes a task distributor 1410. Further, the task distributor 1410 is configured for assigning one or more preparation steps to one or more household members based on the skills of the one or more household members and the availability of the one or more household members. Further, the task distributor 1410 is further configured for balancing a workload.

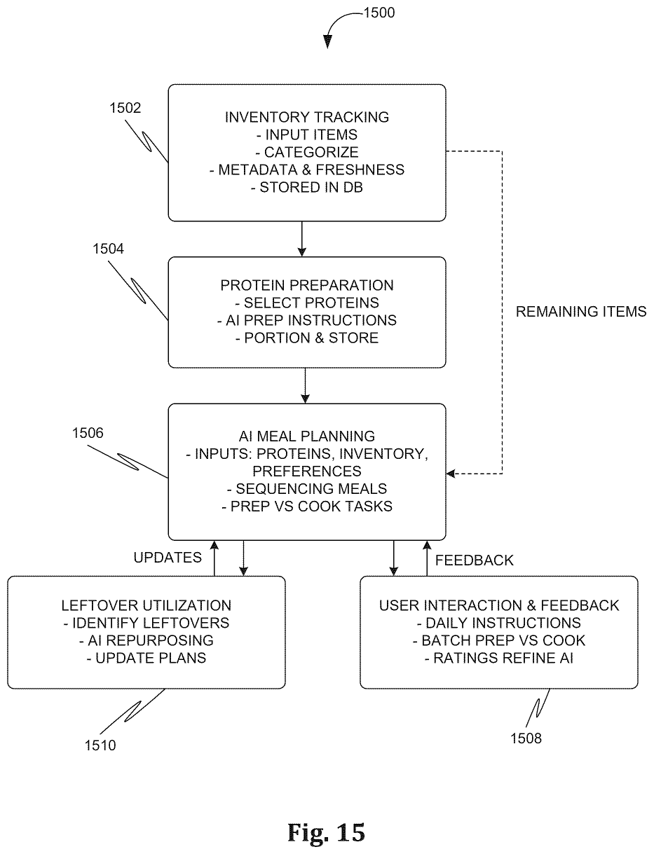

FIG. 15 illustrates a flowchart of a method 1500 of facilitating planning of meals for users, in accordance with some embodiments. Further, in some embodiments, the method 1500 includes a step 1502 of receiving, using the communication device 806, the two or more food item information of the two or more food items. Further, the method 1500 further includes classifying, using the processing device 804, the two or more food items into one or more categories. Further, the method 1500 includes assigning, using the processing device 804, metadata to the one or more food items based on the classifying of the two or more food items into the one or more categories. Further, the method 1500 further includes storing, using the storage device 802, the one or more food item information of the two or more food items in the database. Further, in some embodiments, the method 1500 further includes a step 1504 of selecting, using the processing device 804, one or more proteins from the two or more food items. Further, the method 1500 includes generating, using the processing device 804, one or more preparation instructions based on the selecting of the one or more proteins. Further, the method 1500 further includes calculating, using the processing device 804, one or more optimal portion sizes based on one or more user data. Further, the one or more user data comprises the household size, the dietary preference, and the upcoming meal of the one or more users. Further, in some embodiments, the method 1500 further includes a step of 1506 of analyzing, using the processing device 804, the two or more food information of the two or more food items and the one or more user data. Further, the scheduling, using the processing device, one or more meals based on the analyzing of the two or more food information of the two or more food items and the one or more user data. Further, in some embodiments, the method 1500 further includes transmitting, using the communication device 806, one or more scheduled meals to the one or more devices. Further, the method 1500 includes a step 1508 of receiving, using the communication device 806, the user feedback data from one or more devices. Further, the user feedback data comprises one or more leftover food data, and a user rating. Further, the method 1500 further includes a step 1510 of identifying, using the processing device 804, the one or more leftover food items. Further, the method 1500 further includes assigning, using the processing device 804, the one or more leftover food data to one or more recipes. Further, the method 1500 includes updating, using the processing device 804, the meal plan based on the user feedback data.

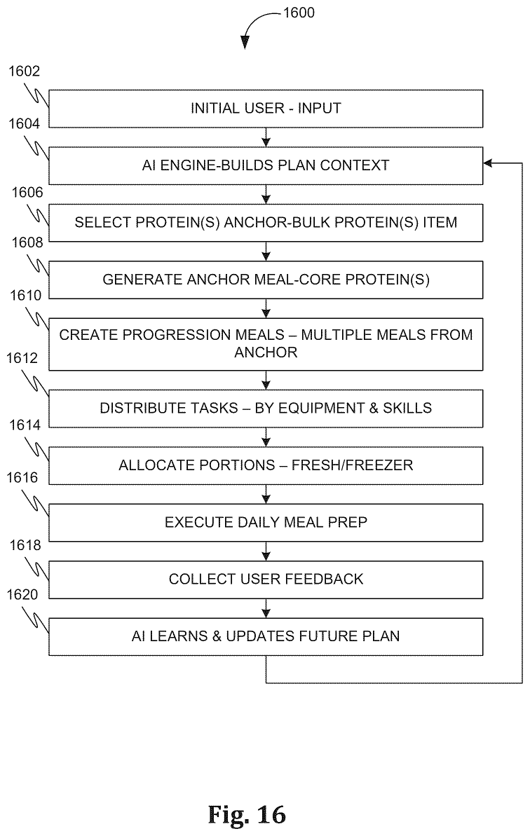

FIG. 16 illustrates a flowchart of a method 1600 of facilitating planning of meals for users, in accordance with some embodiments. Further, the method 1600 may include a step 1602 of receiving initial user input, a step 1604 of AI engine building plan context, a step 1606 of selecting protein anchor(s), a step 1608 of generating anchor meal, a step 1610 of creating progression meals, a step 1612 of distributing tasks, a step 1614 of allocating portions (fresh/freezer), a step 1616 of executing daily meal preparation, a step 1618 of collecting user feedback, and a step 1620 of AI learning and updating future plans. Further, the step 1620 is connected to step 1604.

Further, the receiving of the initial user input includes capturing household data (profiles, schedules, equipment, and inventory). Further, the AI engine building plan context includes creating planning constraints and recipe graph seed. Further, the selection of the protein anchor(s) includes choosing bulk protein(s) as core anchor(s). Further, the generation of the anchor meal includes preparing the initial large protein-based dish. Further, the creation of the progression meals includes transforming the anchor into multiple derivative meals. Further, the distribution of the tasks includes assigning cooking steps to members by skill and available appliances. Further, the allocation of the portions (fresh/freezer) includes split meals for immediate vs. later use. Further, the executing of the daily meal prep includes performing planned cooking steps and record results. Further, the collection of the user feedback includes recording satisfaction, leftovers, spoilage, and prep metrics. Further, the AI learning & updating of the future plan includes adjusting anchor selection and planning for next cycle.

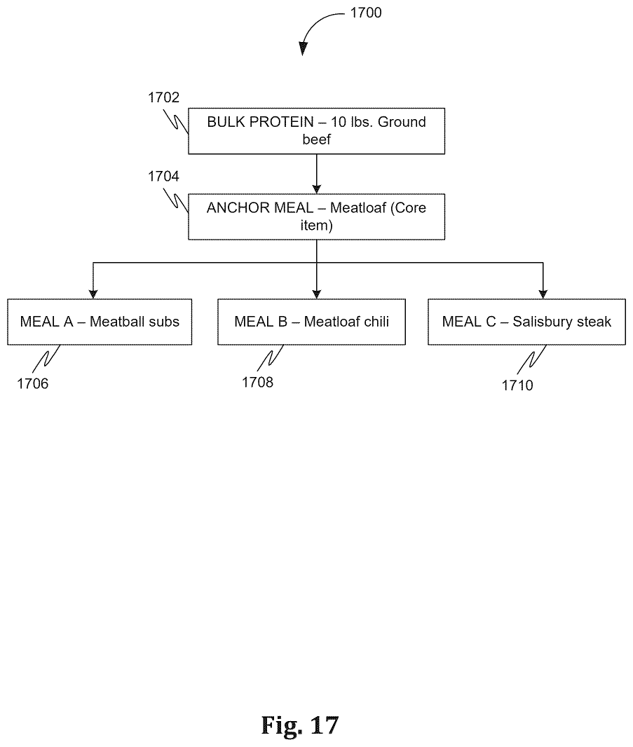

FIG. 17 illustrates a flowchart of a method 1700 of facilitating a meal preparation, in accordance with some embodiments. Further, the method 1700 includes selecting, using processing device 804, a first bulk protein 1702 for the meal planning. Further, the first bulk protein 1702 comprises ten lbs of ground beef. Further, the method 1700 includes determining, using the processing device 804, a first anchor meal 1704 based on the selecting of the first bulk protein 1702. Further, the first anchor meal 1704 comprises a meatloaf. Further, the method 1700 further includes dividing, using the processing device 804, the first anchor meal into a first derivative meal 1706 (Meal A), a second derivative meal 1708 (Meal B), and a third derivative meal 1710 (Meal C). Further, the first derivative meal 1706 comprises a meatball sub. Further, the second derivative meal 1708 comprises a meatloaf chili. Further, the third derivative meal 1710 comprises a Salisbury steak.

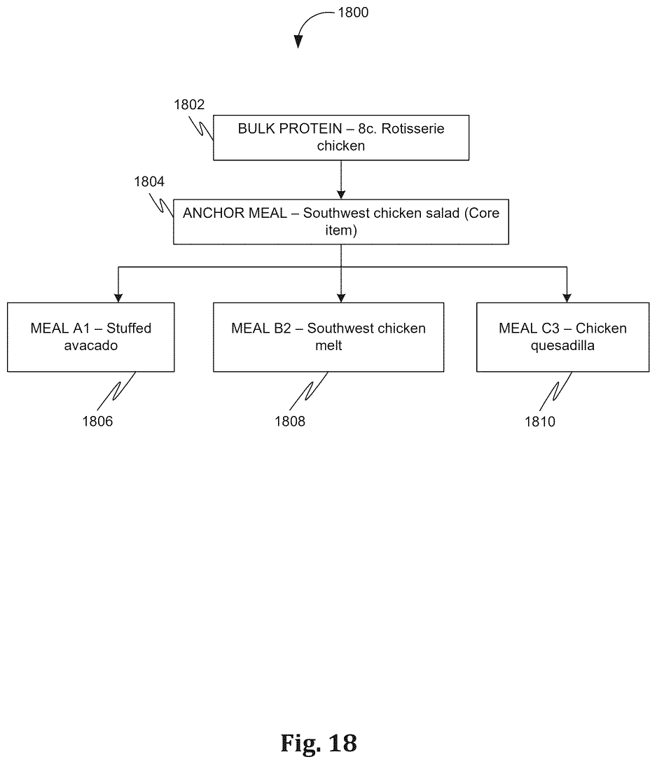

FIG. 18 illustrates a flowchart of a method 1800 of facilitating meal preparation, in accordance with some embodiments. Further, the method 1800 includes selecting, using processing device 804, a second bulk protein 1802 for the meal planning. Further, the second bulk protein 1802 comprises a rotisserie chicken. Further, the method 1800 includes determining, using the processing device 804, a second anchor meal 1804 based on the selecting of the second bulk protein 1802. Further, the second anchor meal comprises a southwest chicken salad. Further, the method 1800 further includes dividing, using the processing device 804, the second anchor meal 1804 into a meal A1 1806, a meal B2 1808, and a meal C3 1810. Further, the meal A1 1806 comprises a stuffed avocado. Further, the meal B2 1806 comprises a southwest chicken melt. Further, the meal C3 1810 comprises a chicken quesadilla.

Although the invention has been explained in relation to its preferred embodiment, it is to be understood that many other possible modifications and variations can be made without departing from the spirit and scope of the invention as hereinafter claimed.

What is claimed is:

1. A method of facilitating planning of meals for users, the method comprising:
retrieving, using a storage device, a meal plan information of a meal plan for at least one user, wherein the meal plan comprises a plurality of meals at a plurality of mealtimes;
accessing, using a processing device, at least one database, wherein the at least one database comprises a plurality of food item information of a plurality of food items, wherein each of the food item information corresponds to a respective one of the plurality of food items;
executing, using the processing device, at least one Artificial Intelligence (AI) model based on the accessing and the retrieving, wherein the at least one AI model is configured for:
processing the plurality of food item information of the plurality of food items based on the meal plan information; and
selecting at least one food item from the plurality of food items for a meal using at least one variable associated with the at least one user based on the processing of the plurality of food item information; and
generating, using the processing device, at least one instruction for creating the meal based on the selecting;
transmitting, using a communication device, the at least one instruction to at least one device associated with the at least one user; and
storing, using the storage device, the at least one variable.

2. The method of claim 1 further comprising:
analyzing, using the processing device, the meal plan information;
determining, using the processing device, a preparation time for the meal required to be created at a meal time of the meal based on the analyzing of the meal plan information;
identifying, using the processing device, at least one raw food item from the plurality of food items for the meal based on the analyzing of the meal plan information, the determining of the preparation time for the meal required to be created at the meal time, and the plurality of food item information;
analyzing, using the processing device, at least one raw food item information of the at least one raw food item using at least one criterion based on the accessing of the at least one database, and the identifying of the at least one raw food item;
generating, using the processing device, at least one processing instruction for processing the at least one raw food item into at least one processed food item during the preparation time based on the analyzing of the at least one raw food item information;
generating, using the processing device, at least one processed food item information for the at least one processed food item based on the generating of the at least one processing instruction; and
storing, using the storage device, the at least one processed food item information of the at least one processed food item in the at least one database, wherein the at least one food item information corresponding to the at least one processed food item comprises the at least one processed food item information.

3. The method of claim 2, wherein the at least one AI model is further configured for:
identifying a plurality of raw food items from the plurality of food items based on the processing of the plurality of food item information;
analyzing a plurality of raw food item information comprised in the plurality of food item information;
determining a priority of each of the plurality of raw food items based on the analyzing of the plurality of food item information; and
generating a priority score for the priority of each of the plurality of raw food items based on the priority of each of the plurality of food items, wherein the at least one food item comprises at least one raw food item and at least one additional food item, wherein the selecting of the at least one food item comprises:
selecting the at least one raw food item for the meal using the at least one variable associated with the at least one user based on the plurality of food item information, and the meal plan information; and
selecting the at least one additional food item for the meal using the at least one variable associated with the at least one user based on the plurality of food item information, and the meal plan information, wherein the selecting of the at least one raw food item comprises selecting the at least one raw food item from the plurality of raw food items based on the priority score of each of the plurality of raw food items.

4. The method of claim 1, wherein the at least one AI model is further configured for:
identifying a plurality of leftover food items from the plurality of food items based on the plurality of food item information;
analyzing a plurality of leftover food item information of the plurality of leftover food items based on the meal plan information;
determining a repurposability of each of the plurality of leftover food items for the meal based on the analyzing of the plurality of leftover food item information, wherein the selecting of the at least one food item from the plurality of food items for the meal is further based on the repurposability of each of the plurality of leftover food items, wherein the at least one food item further comprises at least one leftover food item of the plurality of leftover food items.

5. The method of claim 1 further comprising updating, using the processing device, the at least one database after the creating of the meal, wherein the updating of the at least one database comprises updating the at least one food item information associated with the at least one food item.

6. The method of claim 1 further comprising:
obtaining, using the processing device, a meal consumption information of the meal after a consumption of the meal;
analyzing, using the processing device, the meal consumption information;
identifying, using the processing device, at least one leftover food item unconsumed in the meal based on the analyzing of the meal consumption information;
generating, using the processing device, at least one leftover food item information for the at least one leftover food item based on the analyzing of the meal consumption information, and the identifying of the at least one leftover food item;
updating, using the processing device, the at least one database after the consumption of the meal, wherein the updating of the at least one database comprises adding the at least one leftover food item information of the at least one leftover food item in the at least one database, wherein the plurality of food item information comprises the at least one leftover food item information, and the plurality of food items comprises the at least one leftover food item; and
storing, using the storage device, the meal consumption information.

7. The method of claim 6 further comprising:
retrieving, using the storage device, at least one previous meal consumption information associated with at least one previous meal;
analyzing, using the processing device, the at least one previous meal consumption information; and
determining, using the processing device, a meal consumption pattern for the at least one user based on the analyzing of the at least one previous meal consumption information, and the analyzing of the meal consumption information, wherein the selecting of the at least one food item is further based on the meal consumption pattern.

8. The method of claim 1 further comprising updating, using the processing device, the meal plan based on the meal consumption pattern, wherein the updating of the meal plan comprises updating at least one future meal information of at least one future meal of the plurality of meals.

9. The method of claim 8 further comprising:
receiving, using the communication device, at least one feedback for the meal from the at least one device; and
analyzing, using the processing device, the at least one feedback, wherein the updating of the meal plan is further based on the analyzing of the at least one feedback.

10. The method of claim 1 further comprising updating, using the processing device, the at least one database after an elapse of a time period, wherein the updating of the at least one database comprises:
analyzing the plurality of food item information of the plurality of food items after the elapse of the time period;
determining an update corresponding to at least one of the plurality of food items based on the analyzing of the plurality of food item information, and the time period; and
modifying at least one parameter comprised in at least one of the plurality of food item information associated with at least one of the plurality of food items.

11. A system for facilitating planning of meals for users, the system comprising:
a storage device configured for:
retrieving a meal plan information of a meal plan for at least one user, wherein the meal plan comprises a plurality of meals at a plurality of mealtimes;
a processing device communicatively coupled with the storage device, wherein the processing device is configured for:
accessing at least one database, wherein the at least one database comprises a plurality of food item information of a plurality of food items, wherein each of the food item information corresponds to a respective one of the plurality of food items;
executing at least one Artificial Intelligence (AI) model based on the accessing and the retrieving, wherein the at least one AI model is configured for:
processing the plurality of food item information of the plurality of food items based on the meal plan information; and
selecting at least one food item from the plurality of food items for a meal using at least one variable associated with the at least one user based on the processing of the plurality of food item information; and
a communication device communicatively coupled with the processing device wherein the communication device is configured for:
transmitting the at least one instruction to at least one device associated with at least one user.

12. The system of claim 11, wherein the processing device is further configured for:
analyzing the meal plan information;
determining a preparation time for the meal required to be created at a meal time of the meal based on the analyzing of the meal plan information;
identifying at least one raw food item from the plurality of food items for the meal based on the analyzing of the meal plan information, the determining of the preparation time for the meal required to be created at the meal time, and the plurality of food item information;
analyzing at least one raw food item information of the at least one raw food item using at least one criterion based on the accessing of the at least one database, and the identifying of the at least one raw food item;
generating at least one processing instruction for processing the at least one raw food item into at least one processed food item during the preparation time based on the analyzing of the at least one raw food item information; and
generating at least one processed food item information for the at least one processed food item based on the generating of the at least one processing instruction, wherein the storage device is further configured for storing the at least one processed food item information of the at least one processed food item in the at least one database, wherein the at least one food item information corresponding to the at least one processed food item comprises the at least one processed food item information.

13. The system of claim 12, wherein the at least one AI model is further configured for:
identifying a plurality of raw food items from the plurality of food items based on the processing of the plurality of food item information;
analyzing a plurality of raw food item information comprised in the plurality of food item information;
determining a priority of each of the plurality of raw food items based on the analyzing of the plurality of food item information; and
generating a priority score for the priority of each of the plurality of raw food items based on the priority of each of the plurality of food items, wherein the at least one food item comprises at least one raw food item and at least one additional food item, wherein the selecting of the at least one food item comprises:
selecting the at least one raw food item for the meal using the at least one variable associated with the at least one user based on the plurality of food item information, and the meal plan information; and
selecting the at least one additional food item for the meal using the at least one variable associated with the at least one user based on the plurality of food item information, and the meal plan information, wherein the selecting of the at least one raw food item comprises selecting the at least one raw food item from the plurality of raw food items based on the priority score of each of the plurality of raw food items.

14. The system of claim 11, wherein the at least one AI model is further configured for:
identifying a plurality of leftover food items from the plurality of food items based on the plurality of food item information;
analyzing a plurality of leftover food item information of the plurality of leftover food items based on the meal plan information;
determining a repurposability of each of the plurality of leftover food items for the meal based on the analyzing of the plurality of leftover food item information, wherein the selecting of the at least one food item from the plurality of food items for the meal is further based on the repurposability of each of the plurality of leftover food items, wherein the at least one food item further comprises at least one leftover food item of the plurality of leftover food items.

15. The system of claim 11, wherein the processing device is further configured for updating the at least one database after the creating of the meal, wherein the updating of the at least one database comprises updating the at least one food item information associated with the at least one food item.

16. The system of claim 11, wherein the processing device is further configured for:
obtaining a meal consumption information of the meal after a consumption of the meal;
analyzing the meal consumption information;
identifying at least one leftover food item unconsumed in the meal based on the analyzing of the meal consumption information;
generating at least one leftover food item information for the at least one leftover food item based on the analyzing of the meal consumption information, and the identifying of the at least one leftover food item; and
updating the at least one database after the consumption of the meal, wherein the updating of the at least one database comprises adding the at least one leftover food item information of the at least one leftover food item in the at least one database, wherein the plurality of food item information comprises the at least one leftover food item information, and the plurality of food items comprises the at least one leftover food item, wherein the storage device is further configured for storing the meal consumption information.

17. The system of claim 16, wherein the storage device is further configured for retrieving at least one previous meal consumption information associated with at least one previous meal, wherein the processing device is further configured for:
analyzing the at least one previous meal consumption information; and
determining a meal consumption pattern for the at least one user based on the analyzing of the at least one previous meal consumption information, and the analyzing of the meal consumption information, wherein the selecting of the at least one food item is further based on the meal consumption pattern.

18. The system of claim 11, wherein the processing device is further configured for updating the meal plan based on the meal consumption pattern, wherein the updating of the meal plan comprises at least one future meal information of at least one future meal of the plurality of meals.

19. The system of claim 18, wherein the communication device is further configured for receiving at least one feedback for the meal from the at least one device, wherein the processing device is further configured for analyzing the at least one feedback, wherein the updating of the meal plan is further based on the analyzing of the at least one feedback.

20. The system of claim 11, wherein the processing device is further configured for updating the at least one database after an elapse of a time period, wherein the updating of the at least one database comprises:
analyzing the plurality of food item information of the plurality of food items after the elapse of the time period;
determining an update corresponding to at least one of the plurality of food items based on the analyzing of the plurality of food item information, and the time period; and
modifying at least one parameter comprised in at least one of the plurality of food item information associated with at least one of the plurality of food items.
